(19) United States
(12) Patent Application Publication
(10) Pub. No.: US 2026/0138010 A1
(43) Pub. Date: May 21, 2026

(54) METHOD FOR PROCESSING BLOCKCHAIN RESOURCES AND APPARATUS, ELECTRONIC DEVICE, STORAGE MEDIUM, AND PROGRAM PRODUCT

(71) Applicant: TENCENT TECHNOLOGY (SHENZHEN) COMPANY LIMITED, Shenzhen (CN)

(72) Inventors: Zhiyong LIAO, Shenzhen (CN); Zongyou WANG, Shenzhen (CN); Yifang SHI, Shenzhen (CN); Gengliang ZHU, Shenzhen (CN); Qucheng LIU, Shenzhen (CN); Hanqing LIU, Shenzhen (CN); Yangjun HUANG, Shenzhen (CN); Kaixuan NIE, Shenzhen (CN)

(21) Appl. No.: 19/452,213

(22) Filed: Jan. 16, 2026

Related U.S. Application Data
(63) Continuation of application No. PCT/CN2024/106935, filed on Jul. 23, 2024.

(30) Foreign Application Priority Data
Oct. 9, 2023 (CN) 202311307275.5

(51) Int. Cl. A63F 13/35; H04L 67/104; H04L 67/131

(52) U.S. Cl. CPC A63F 13/35; H04L 67/104; H04L 67/131

(57) ABSTRACT

Embodiments of this application provide a method for processing blockchain resources, including deploying a target resource package in the master contract in response to a deployment request of a first object for the target resource package; receiving a binding request of the first object for a plurality of target resources to be bound in the target resource package, a second owner of each target resource to be bound in a sub-contract corresponding to the target resource to be bound being already registered as the first object; changing the second owner from the first object to an address of the master contract in response to the binding request, to determine the target resource to be bound as a bound target resource; and changing a first owner of the bound target resource to a second object in response to an ownership transfer request of the second object for the bound target resource.

### RELATED APPLICATIONS

This application is a continuation of PCT Application No. PCT/CN2024/106935 filed on Jul. 23, 2024, which claims priority to Chinese Patent Application No. 202311307275.5, filed with the China National Intellectual Property Administration on Oct. 9, 2023, and entitled “METHOD FOR PROCESSING BLOCKCHAIN RESOURCES, RELATED APPARATUS, AND MEDIUM”, which are incorporated herein by reference in their entirety.

### FIELD OF THE TECHNOLOGY

Embodiments of this application relates to the blockchain field, and in particular, to a method for processing blockchain resources and apparatus, an electronic device, a storage medium, and a program product.

### BACKGROUND OF THE DISCLOSURE

Currently, a blockchain network is often configured for resource scheduling and transfer. With development of blockchains, a same resource may be scheduled and transferred on a plurality of application platforms (for example, game platforms). For example, an armor in a game may be simultaneously configured for game A, game B, game C, and the like, and may be obtained in game A, game B, game C, and the like, and transferred to other objects in game A, game B, game C, and the like. There is usually a requirement of collectively transferring resources collected on different application platforms. For example, armors separately collected in game A, game B, and game C are transferred to another object together as one set.

However, one resource in the resource set often needs to be independently transferred and scheduled on an application platform on which the resource is obtained. Thus, transfer and scheduling efficiency is low, and interoperability across the application platforms is low.

### SUMMARY

Embodiments of this application provide a method for processing blockchain resources and apparatus, an electronic device, a storage medium, and a program product, to improve resource transfer and scheduling efficiency, and improve interoperability across application platforms.

An embodiment of this application provides a method for processing blockchain resources, performed by an electronic device, the electronic device corresponding to a blockchain node; the blockchain node being connected to a plurality of application platforms, and maintaining, on a blockchain, a sub-contract configured for each application platform and a master contract configured for the plurality of application platform; and the method including:
deploying a target resource package in the master contract in response to a deployment request of a first object for the target resource package, the target resource package comprising a plurality of target resources on the plurality of application platforms, and a first owner of each of the plurality of target resources being the first object;
receiving a binding request of the first object for a plurality of target resources to be bound in the target resource package, a second owner of each target resource to be bound in a sub-contract corresponding to the target resource to be bound being already registered as the first object;
changing the second owner from the first object to an address of the master contract in response to the binding request, to determine the target resource to be bound as a bound target resource; and
changing a first owner of the bound target resource to a second object in response to an ownership transfer request of the second object for the bound target resource.

In addition, an embodiment of this application provides an electronic device, including a memory and a processor, the memory having a computer program stored therein, and the processor, when executing the computer program, implementing the method for processing blockchain resources described above.

In addition, an embodiment of this application provides a non-transitory computer-readable storage medium, the storage medium having a computer program stored therein, and the computer program, when executed by a processor, implementing the method for processing blockchain resources described above.

### BRIEF DESCRIPTION OF THE DRAWINGS

The accompanying drawings are configured for providing a further understanding of technical solutions of this application, constitute a part of the specification, are configured for explaining the technical solutions of this application in combination with embodiments of this application, and do not constitute a limitation on the technical solutions of this application.

FIG. 1 is a schematic diagram of a system architecture in which a blockchain node is connected to an application platform and to which an embodiment of this application is applied.

FIG. 2A to FIG. 2G are schematic diagrams of one type of service scenarios of a method for processing blockchain resources according to embodiments of this application.

FIG. 3 is a flowchart of a method for processing blockchain resources according to an embodiment of this application.

FIG. 4 is a flowchart of a specific implementation of operation 310 in FIG. 3.

FIG. 5 is a flowchart of determining that a plurality of target resources to be bound fall within an initial target resource list according to another embodiment of this application.

FIG. 6 is a flowchart of a specific implementation of operation 520 in FIG. 5.

FIG. 7 is a schematic diagram of an embodiment of determining that a target resource to be bound falls within the initial target resource list in FIG. 6.

FIG. 8 is a flowchart of another specific implementation of operation 620 in FIG. 6.

FIG. 9 is a schematic diagram of a specific implementation of determining that a target resource to be bound falls within an initial target resource list based on a second variable in FIG. 8.

FIG. 10 is a flowchart of a specific implementation of operation 330 in FIG. 3.

FIG. 11A to FIG. 11C are schematic diagrams of specific implementations of binding a target resource based on a type of a second sub-contract address in FIG. 10.

FIG. 12 is a flowchart of processing an unbinding request according to another embodiment of this application.

FIG. 13 is a flowchart of determining that a plurality of target resources to be unbound fall within an initial target resource list according to another embodiment of this application.

FIG. 14 is a flowchart of processing a quantity of target resources to be unbound according to another embodiment of this application.

FIG. 15 is a schematic diagram of a specific implementation of unbinding a target resource from a bound target resource based on a second variable in FIG. 14.

FIG. 16 is a flowchart of processing a target resource to be unbound according to another embodiment of this application.

FIG. 17 is a flowchart of a specific implementation of operation 1430 in FIG. 14.

FIG. 18 is a flowchart of transmitting an initial target resource list according to another embodiment of this application.

FIG. 19 is a module diagram of a blockchain resource processing apparatus according to an embodiment of this application.

FIG. 20 is a structural diagram of a terminal of a method for processing blockchain resources according to an embodiment of this application.

FIG. 21 is a structural diagram of a server of a method for processing blockchain resources according to an embodiment of this application.

### DESCRIPTION OF EMBODIMENTS

To make the objectives, technical solutions, and advantages of this application clearer, the following further describes this application in detail with reference to the accompanying drawings and embodiments. The specific embodiments described herein are merely configured for explaining this application but are not intended to limit this application.

In the embodiments of this application, in the specific implementations of this application, when relevant processing needs to be performed based on data related to characteristics of a target object, such as attribute information or an attribute information set of the target object, permission or consent of the target object is first obtained, and collection, use, and processing of such data all comply with relevant laws, regulations, and standards. In addition, when the attribute information of the target object needs to be obtained in the embodiments of this application, individual permission or individual consent of the target object is obtained by popping up a window, jumping to a confirmation page, or the like. After the individual permission or individual consent of the target object is explicitly obtained, relevant data of the target object that is necessary for ensuring normal operation of the embodiments of this application is obtained.

Before the embodiments of this application are further described in detail, nouns and terms in the embodiments of this application are described, and the nouns and terms in the embodiments of this application are applicable to the following explanations.

A blockchain is a new application mode of computer technologies such as distributed data storage, a consensus mechanism, and an encryption algorithm. The blockchain is essentially a decentralized database, and is a string of data blocks generated in a cryptographic manner. Each data block includes information about a batch of transactions, which is configured for verifying validity (anti-counterfeiting) of the information and associating with a previous block.

A blockchain node, a node of a blockchain, generally refers to a computer in a blockchain network, or any computer connected to the blockchain network is referred to as a node. Generally, the blockchain node has three features: First, the node has storage space, and can store block data in a device such as a removable hard disk and a computer. Second, the node is connected to the network, and all devices with storage space need be connected to the network. Third, the node participates in the blockchain, needs to run a corresponding blockchain program in the storage space, and executes an on-chain transaction via a visual terminal.

A virtual resource is an information resource edited by using a database and a program. On an application platform, specific data processing may be performed on the virtual resource according to some data protocol standards. In different service scenarios, types of non-homogeneous virtual resources can also be diverse. For example, the non-homogeneous virtual resource may be a virtual painting, a virtual equipment, or a virtual resource of another type.

A service contract refers to a section of code written on the blockchain. Once a term in the service contract is triggered for execution on the blockchain at a time point, the code is to run automatically. The service contract is a computer protocol aimed at propagating, verifying, or executing a transaction in an information-based manner. The service contract is in a digital form, and is written into computer-readable code. Once participants of the service contract reach an agreement, rights and obligations established based on the service contract are to be executed by a computer or a computer network through the code on the blockchain.

Currently, a blockchain network is often configured for resource scheduling and transfer. With development of blockchains, a same resource may be scheduled and transferred on a plurality of application platforms (for example, game platforms). For example, an armor in a game may be simultaneously configured for a game A, a game B, a game C, and the like, and may be obtained in game A, game B, game C, and the like, and transferred to other objects in game A, game B, game C, and the like.

In one embodiment, there is usually a requirement of collectively transferring resources collected on different application platforms. For example, armors separately collected in game A, game B, and game C are transferred to another object together as one set.

Data protocol standards followed by different application platforms may be different. The armor in the game is used as a non-homogeneous virtual equipment. Data forms of the same armor stored in different application platforms are also different. In this case, due to limitations of the related art, each resource in the resource set needs to be transferred and scheduled separately on an application platform on which the resource is obtained. However, the resources in the resource set cannot be transferred or scheduled as a whole. Consequently, resource transfer and scheduling efficiency is low, and interoperability across the application platforms is low.

A system architecture and scenarios to which the embodiments of this application are applied are described below.

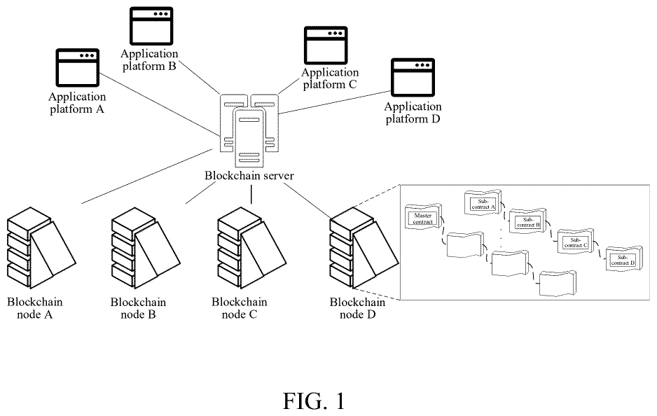

A blockchain resource transfer processing network shown in FIG. 1 includes:
an application platform A, an application platform B, an application platform C, and an application platform D, which are four types of application platforms. The application platform in this embodiment of this application refers to a network platform that bears a blockchain application.

A blockchain node A, a blockchain node B, a blockchain node C, and a blockchain node D are all nodes on a blockchain. In this embodiment of this application, the blockchain node has three features:

First, the node has storage space, and can store block data in a device such as a removable hard disk and a computer.

Second, the node is connected to a network, and all devices with storage space need be connected to the network.

Third, the node participates in running the blockchain, can run a corresponding blockchain program in the storage space, and executes an on-chain transaction via a visual terminal.

In this embodiment of this application, the blockchain node A, the blockchain node B, the blockchain node C, and the blockchain node D maintain, on the blockchain, a plurality of sub-contracts corresponding to a plurality of application platforms and a master contract configured for the plurality of application platforms.

In a service scenario shown in FIG. 1, a sub-contract A corresponding to the application platform A, a sub-contract B corresponding to the application platform B, a sub-contract C corresponding to the application platform C, and a sub-contract D corresponding to the application platform D are stored in different blocks of the same blockchain. a master contract, different from the sub-contracts, of the application platform A, the application platform B, the application platform C, and the application platform D is stored in another blockchain.

FIG. 1 shows a blockchain resource transfer processing network according to an embodiment of this application. Storage of a contract in a blockchain is not limited to FIG. 1. To be specific, the plurality of sub-contracts corresponding to the plurality of application platforms are not necessarily stored in the same blockchain, and the sub-contracts and the master contract are not necessarily stored in different blockchains.

A blockchain server refers to a server configured to allocate data to be chained to a corresponding blockchain node and control each blockchain node to maintain a blockchain. The blockchain node is connected to the application platform via the blockchain server.

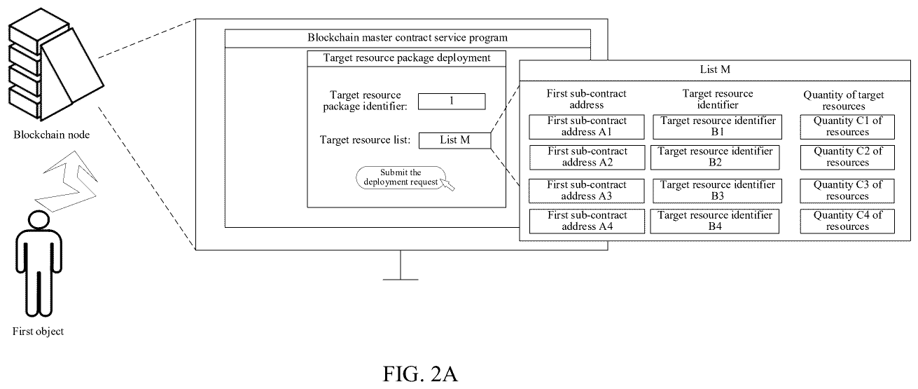

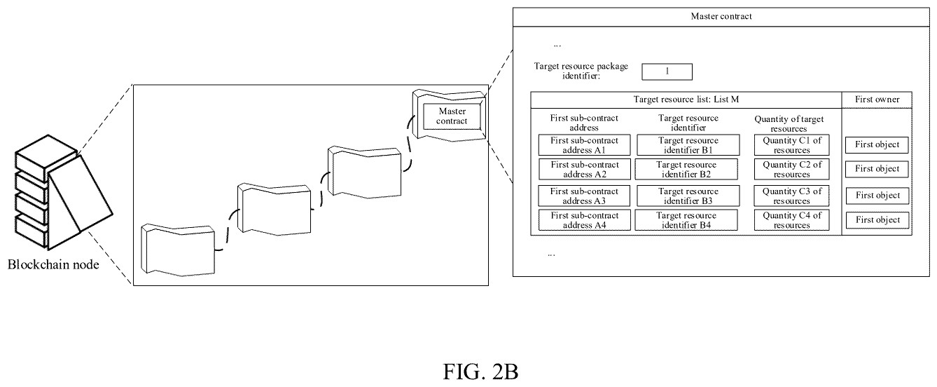

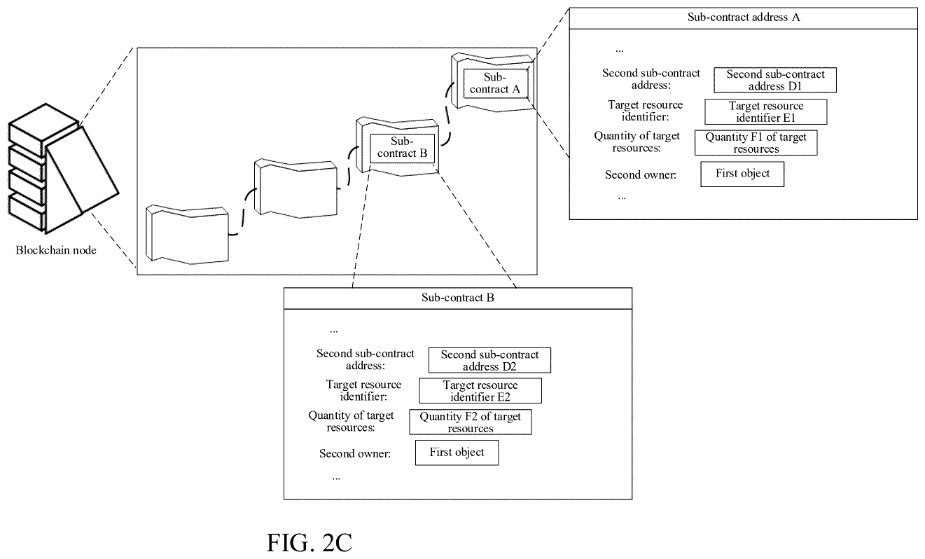

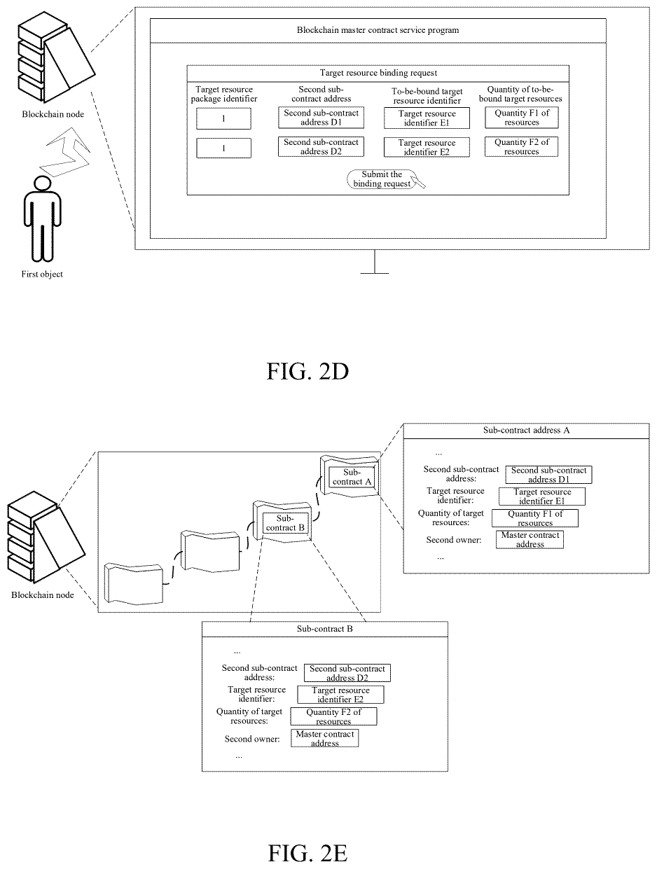

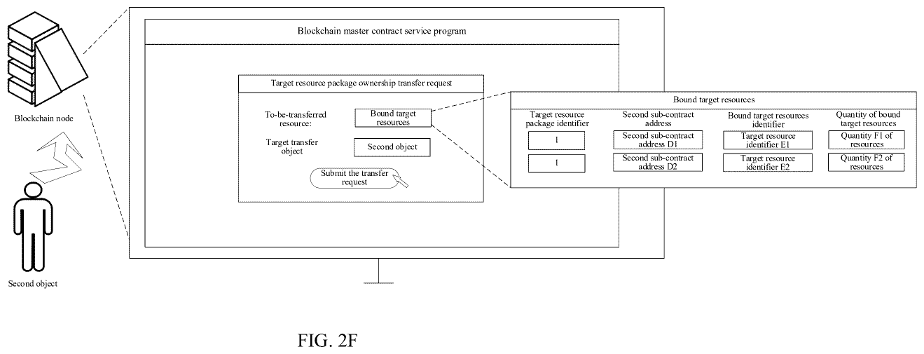

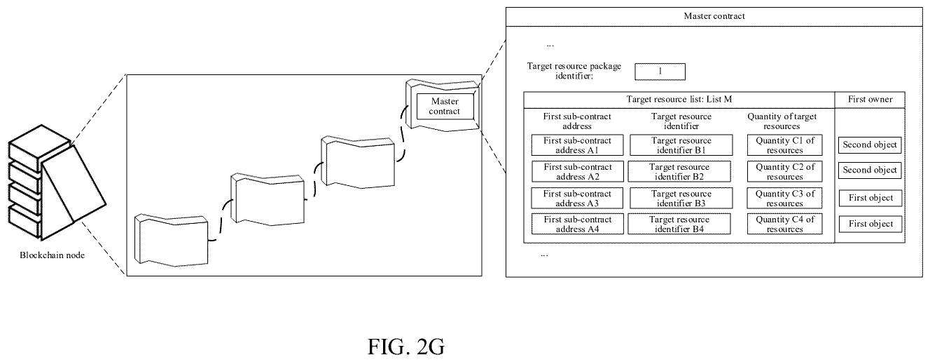

The embodiments of this application may be applied to a plurality of scenarios, such as scenarios, shown in FIG. 2A to FIG. 2G, in which virtual resources of an application platform A and an application platform B are transferred as a whole. In the embodiments of this application, a sub-contract A is a service contract for storing a virtual resource in the application platform A, and a sub-contract B is a service contract for storing a virtual resource in the application platform B. To transfer the virtual resources on the application platform A and the application platform B as a whole from a first object to a second object, this application provides the embodiments shown in FIG. 2A to FIG. 2G.

Refer to FIG. 2A. To facilitate collectively transferring and scheduling the resources, the first object delivers a target resource package deployment request to a blockchain node, aiming to integrate resources collected on different application platforms into a target resource package. The target resource package is deployed in a master contract on a blockchain, and a first owner of the target resource package is set as the first object. Accordingly, first owners of all target resources in the target resource package are all the first object.

The target resource package deployment request may include a target resource package identifier and a target resource list. The target resource package identifier is configured for distinguishing between different target resource packages, and the target resource list is configured for recording resource storage statuses of the first object on different application platforms.

In FIG. 2A, a target resource package identifier, corresponding to a target resource package, being 1 may indicate that a number of a currently deployed target resource package is 1, a target resource list corresponding to the target resource package 1 is a list M, and the list M records resource storage statuses of each target resource of the first object in the target resource package on the different application platforms.

Target resource identifiers are configured for distinguishing between different target resources of the first object in the target resource package. A first sub-contract address indicates a storage address of a target resource stored in a corresponding application platform, and a quantity of target resources indicates a quantity of target resources stored at the first sub-contract address.

In the list M, a quantity of target resources that correspond to a target resource identifier B1 and that are stored at a first sub-contract address A1 is C1, a quantity of target resources that correspond to a target resource identifier B2 and that are stored at a first sub-contract address A2 is C2, a quantity of target resources that correspond to a target resource identifier B3 and that are stored at a first sub-contract address A3 is C3, and a quantity of target resources that correspond to a target resource identifier B4 and that are stored at a first sub-contract address A4 is C4.

FIG. 2B shows a contract section in the master contract after the target resource package 1 is deployed. After the first object delivers the target resource package deployment request of the target resource package 1 to the blockchain node, a deployed target resource package is stored in the master contract. Because the target resource corresponding to the target resource identifier B1, the target resource corresponding to the target resource identifier B2, the target resource corresponding to the target resource identifier B3, and the target resource corresponding to the target resource identifier B4 are all deployed by the first object, first owners of the target resources in the master contract are all registered as the first object.

FIG. 2C shows a contract section of the sub-contract A before the sub-contract A of the application platform A is bound to the master contract, and a contract section of the sub-contract B before the sub-contract B of the application platform B is bound to the master contract.

Before the sub-contract A of the application platform A is bound to the master contract, the contract section of the sub-contract A records a second sub-contract address D1, a target resource identifier E1, and a quantity F1 of target resources that are of the sub-contract A, and records a second owner of the target resource corresponding to the target resource identifier E1 in the sub-contract A as the first object.

Before the sub-contract B of the application platform B is bound to the master contract, the contract section of the sub-contract B records a second sub-contract address D2, a target resource identifier E2, and a quantity F2 of target resources that are of the sub-contract B, and records a second owner of the target resource corresponding to the target resource identifier E2 in the sub-contract B as the first object.

For the target resource corresponding to the target resource identifier E1, a quantity of target resources of the first object on the application platform A is F1, and these target resources are stored at the second sub-contract address D1. For the target resource corresponding to the target resource identifier E2, a quantity of target resources of the first object on the application platform B is F2, and these target resources are stored at the second sub-contract address D2.

Refer to FIG. 2D. If a part or all of the target resources in the target resource package are expected to be collectively scheduled or transferred, the first object needs to deliver a binding request for a plurality of target resources, and invoke sub-contracts on the blockchain, so that second owners of the target resources to be bound to be collectively scheduled or transferred in the sub-contracts are all changed to an address of the master contract. Accordingly, the target resource to be bound may be determined as a bound target resource bound to the master contract.

In FIG. 2D, the target resources to be bound targeted by the binding request include the target resource corresponding to the target resource identifier E1 and the target resource corresponding to the target resource identifier E2. The target resource corresponding to the target resource identifier E1 is collected in the target resource package 1 and is stored at the second sub-contract address D1, and a storage quantity is the quantity F1 of target resources. The target resource corresponding to the target resource identifier E2 is collected in the target resource package 1 and is stored at the second sub-contract address D2, and a storage quantity is the quantity F2 of target resources.

Refer to FIG. 2E. After the binding request in FIG. 2D is delivered, resource ownership transfer functions in the sub-contracts on the blockchain are invoked, so that the second owners of the target resources to be bound to be collectively scheduled or transferred in the sub-contracts are all changed to the address of the master contract, to determine the target resource to be bound as the bound target resource.

It may be determined with reference to FIG. 2C that the target resource corresponding to the target resource identifier E1 is stored in the sub-contract A, and a quantity of target resources to be bound is the quantity F1 of target resources stored in the sub-contract A; and the target resource corresponding to the target resource identifier E2 is stored in the sub-contract B, and a quantity of target resources to be bound is the quantity F2 of target resources stored in the sub-contract B.

In view of this, FIG. 2E shows that after the binding request is delivered, the second owners of the target resources to be bound in the sub-contracts are all changed to the address of the master contract. To be specific, for the target resource corresponding to the target resource identifier E1 in the sub-contract A, a second owner of the target resource is changed from the first object to the address of the master contract. In addition, for the target resource corresponding to the target resource identifier E2 in the sub-contract B, a second owner of the target resource is changed from the first object to the address of the master contract.

Refer to FIG. 2F. To collectively schedule or transfer bound target resources, the second object needs to deliver an ownership transfer request for the bound target resource, to change a first owner of the bound target resource to the second object. Previously determined bound target resources, namely, the target resource corresponding to the target resource identifier E1 and the target resource corresponding to the target resource identifier E2, are filled in a “to-be-transferred resource” field in the ownership transfer request. The second object is filled in a “target transfer object” field in the ownership transfer request, to collectively schedule or transfer the bound target resources to the second object.

Referring to FIG. 2G. in a contract section of the master contract, the first owner of the bound target resource is changed to the second object. According to the contract section of the master contract, a bound target resource corresponding to the target resource identifier E1 is collected in the target resource package 1. It may be determined, based on the list M of the target resource package 1, that the target resource identifier E1 corresponding to the bound target resource is equal to the target resource identifier B1, the second sub-contract address D1 of the bound target resource is equal to the first sub-contract address A1, and the corresponding quantity F1 of bound target resources is equal to the quantity C1 of resources. Therefore, the first owner of the target resource corresponding to the target resource identifier B1 in the master contract needs to be changed to the second object.

Similarly, a bound target resource corresponding to the target resource identifier E2 is collected in the target resource package 1. It may be determined, based on the list M of the target resource package 1, that the target resource identifier E2 corresponding to the bound target resource is equal to the target resource identifier B2, the second sub-contract address D2 of the bound target resource is equal to the first sub-contract address A2, and the corresponding quantity F2 of bound target resources is equal to the quantity C2 of resources. Therefore, the first owner of the target resource corresponding to the target resource identifier B2 in the master contract needs to be changed to the second object.

In a normal case, an owner of a target resource may be determined based on a second owner in a sub-contract. However, if the second owner becomes the address of the master contract, the owner of the target resource needs to be determined by searching, based on the address of the master contract, for a first owner to which the target resource belongs in the master contract. The second owners of the bound target resources are all changed to the address of the master contract.

Therefore, once the ownership transfer request of the target resource package is received, the first owners of the target resource package corresponding to the bound target resources are all changed to a transmitter of the transfer request, so that the target resources can be collectively transferred and scheduled without performing complex changes on the application platforms. This improves resource transfer and scheduling efficiency and interoperability across the application platforms.

It is to be emphasized that the embodiments of this application may be applied to various scenarios. FIG. 2A to FIG. 2G shows one type of service scenarios of the embodiments of this application. Service scenarios to which the method for processing blockchain resources in the embodiments of this application may be applied may include, but are not limited to, the specific embodiments listed above.

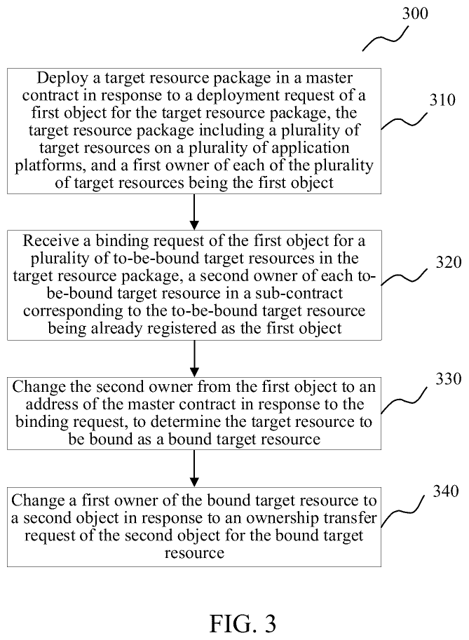

Refer to FIG. 3. A method for processing blockchain resources according to an embodiment of this application is performed by an electronic device. The electronic device corresponds to a blockchain node. The blockchain node is connected to a plurality of application platforms, and maintains, on a blockchain, a sub-contract configured for each application platform and a master contract configured for the plurality of application platform. The method for processing blockchain resources may include, but is not limited to, the following operation 310 to operation 340.

Operation 310: Deploy a target resource package in a master contract in response to a deployment request of a first object for the target resource package, the target resource package including a plurality of target resources on a plurality of application platforms, and a first owner of each of the plurality of target resources being the first object.

Operation 320: Receive a binding request of the first object for a plurality of target resources to be bound in the target resource package, a second owner of each target resource to be bound in a sub-contract corresponding to the target resource to be bound being already registered as the first object.

Operation 330: Change the second owner from the first object to an address of the master contract in response to the binding request, to determine the target resource to be bound as a bound target resource.

Operation 340: Change a first owner of the bound target resource to a second object in response to an ownership transfer request of the second object for the bound target resource.

In operation 310, the deployment request for the target resource package aims to integrate resources collected on different application platforms into the target resource package and deploy the target resource package in the master contract. An objective of the operation is to integrate the resources of the first object on the different application platforms, to collectively transfer and schedule the collected resources.

In this embodiment of this application, in a process of integrating the resources collected on the different application platforms into the target resource package, a first owner is configured for each target resource. When a target resource is uploaded by the first object, a first owner of the target resource may be registered as the first object. When a target resource is scheduled or transferred from the first object to the second object, a first owner of the target resource may be changed from the first object to the second object.

According to some embodiments provided in this application, in operation 330, a resource ownership transfer function in the sub-contract on the blockchain is invoked, to change the second owner of the target resource to be bound in the sub-contract to the address of the master contract. Before this operation, the method for processing blockchain resources may further include, but is not limited to, the following operations:
invoking authorization functions in a plurality of sub-contracts; and
executing the authorization function to authorize the master contract to access the sub-contract, to determine the address of the master contract as the second owner registered on the application platform corresponding to the sub-contract.

Accordingly, the master contract is authorized by using the authorization function in the sub-contract, so that the master contract has permission to invoke the resource ownership transfer function in the sub-contract on the blockchain in a subsequent operation, and the address of the master contract can serve as the second owner registered on the application platform corresponding to the sub-contract. Accordingly, adding an authorization barrier helps improve security of the method for processing blockchain resources in this application. In addition, the address of the master contract can serve as the second owner registered on the application platform corresponding to the sub-contract. This helps facilitate more flexible scheduling and transfer of target resources.

In operation 320, to collectively schedule or transfer resources of the plurality of application platforms, target resources to be bound of the plurality of application platforms need to be bound first.

In this embodiment of this application, collective scheduling or transfer of the resources is initiated by the first object, and the first object may control a resource belonging to the first object. Therefore, second owners of the plurality of target resources to be bound that need to be collectively scheduled or transferred in the sub-contracts are already registered as the first object.

In operation 330, the resource ownership transfer function is configured in the sub-contract, to adjust a resource ownership right on the sub-contract. Therefore, to bind the target resources to be bound of the plurality of application platforms, resource ownership transfer functions in the sub-contracts on the blockchain need to be invoked, so that the second owners of the target resources to be bound in the sub-contracts are changed to the address of the master contract.

Accordingly, the second owner of the target resource to be bound is specifically determined in the master contract based on the address of the master contract, to determine the target resource to be bound as a bound target resource. Based on this, an operation is performed on the master contract, so that second owners of bound resources on the different application platforms can be changed at one time, to complete scheduling and transfer of the bound resources.

In operation 340, after the target resource to be bound is determined as the bound target resource, to transfer the bound target resource, the first owner configured for the bound target resource needs to be changed to the second object in the target resource package.

Accordingly, the bound resources on the different application platforms may be linked to a first owner of the master contract based on the address of the master contract in the second owners of the bound resources, to transfer ownership of the bound resources on the different application platforms to the second object, so that the target resources are collectively transferred and scheduled.

According to this embodiment of this application shown in operation 310 to operation 340, to facilitate collectively transferring and scheduling the resources, the first object integrates the resources collected on the different application platforms into the target resource package. The target resource package is deployed in the master contract on the blockchain, and the first owner of the target resource package is set as the first object. If a part or all of the target resources in the target resource package are expected to be collectively scheduled or transferred, the sub-contracts on the blockchain are invoked, so that second owners of the target resources to be bound to be collectively scheduled or transferred in the sub-contracts are all changed to the address of the master contract. Accordingly, the target resource to be bound may be determined as the bound target resource bound to the master contract.

In a normal case, an owner of a target resource may be determined based on a second owner in a sub-contract. However, if the second owner becomes the address of the master contract, the first owner to which the target resource belongs in the master contract needs to be searched for based on the address of the master contract. Second owners of bound target resources are all changed to the address of the master contract. Therefore, once the ownership transfer request of the target resource package is received, first owners of the target resource package corresponding to the bound target resources are all changed to a transmitter of the transfer request, so that the target resources can be collectively transferred and scheduled without performing complex changes on the application platforms. This improves resource transfer and scheduling efficiency and interoperability across the application platforms.

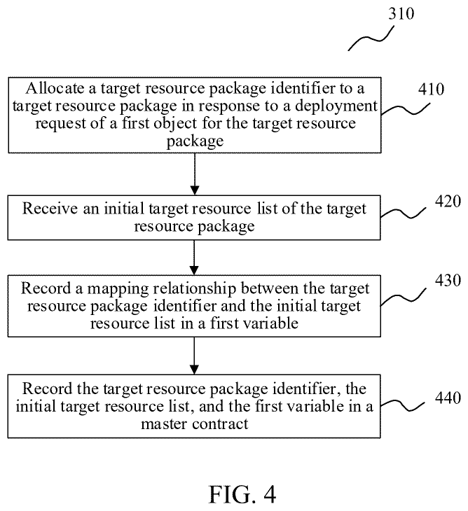

Refer to FIG. 4. In some embodiments of this application, operation 310 may include, but is not limited to, the following operation 410 to operation 440.

Operation 410: Allocate a target resource package identifier to a target resource package in response to a deployment request.

Operation 420: Receive an initial target resource list of the target resource package.

Operation 430: Record a mapping relationship between the target resource package identifier and the initial target resource list in a first variable.

Operation 440: Record the target resource package identifier, the initial target resource list, and the first variable in a master contract.

In operation 410, the deployment request for the target resource package aims to integrate resources collected on different application platforms into the target resource package and deploy the target resource package in the master contract. An objective of the operation is to integrate the resources of a first object on the different application platforms, to collectively transfer and schedule the collected resources.

To distinguish between different target resource packages, target resource package identifiers need to be allocated to the target resource packages. The target resource package identifiers have various types, and may be identifier numbers of the target resource packages, or may be identifier character strings of the target resource packages.

In operation 420, a target resource list is configured for recording resource storage statuses of the first object on the different application platforms. The initial target resource list is a target resource list formed after the resources collected on the different application platforms are integrated into the target resource package, and records a quantity of target resources of the first object registered for the first time on the different application platforms, namely, a quantity of registered target resources.

In some embodiments, for a target resource, the target resource list may record a target resource identifier matching the target resource, a first sub-contract address of the target resource, and a quantity of resources that corresponds to the target resource. Target resource identifiers are configured for distinguishing between different target resources in the target resource package. The first sub-contract address is a storage address of the target resource stored in a sub-contract, and the quantity of resources is a quantity of target resources stored at the first sub-contract address.

The target resource list may record various types of content, which may include, but are not limited to, the specific embodiments listed above.

In some embodiments, after operation 420, the method for processing blockchain resources may further include, but is not limited to: determining that a first sub-contract address corresponding to an initial target resource is of a first type, the first type indicating that the initial target resource is unreproducible; and verifying that a quantity of registered initial target resources is 1.

The type of the sub-contract address may be the first type. The first type indicates that the initial target resource is unreproducible. Therefore, to ensure that the quantity of registered initial target resources matches the first type, it needs to verify that the quantity of registered initial target resources is 1. Accordingly, before the binding request for the plurality of target resources to be bound is received in 320, it may be first determined that the quantity of registered initial target resources matches the first type, and then an unqualified initial target resource may be screened out, to reduce occurrence of invalid resource binding processes. This helps improve accuracy and efficiency of resource binding.

In operation 430 and operation 440, after the initial target resource list of the target resource package is received, the mapping relationship between the target resource package identifier and the initial target resource list needs to be recorded in the first variable. Based on this, because the first variable records the mapping relationship between the target resource package identifier and the initial target resource list, the target resource package identifier, the initial target resource list, and the first variable are recorded in the master contract on a blockchain. This can facilitate subsequent scheduling and transfer of the target resource in the target resource package.

Specific operations of deploying the target resource package in the master contract on the blockchain are described through operation 410 to operation 440 in this embodiment of this application. In a process of deploying the target resource package in the master contract on the blockchain, the target resource package identifier, the initial target resource list, and the first variable are recorded in the master contract on the blockchain. This can facilitate subsequent scheduling and transfer of the target resource in the target resource package.

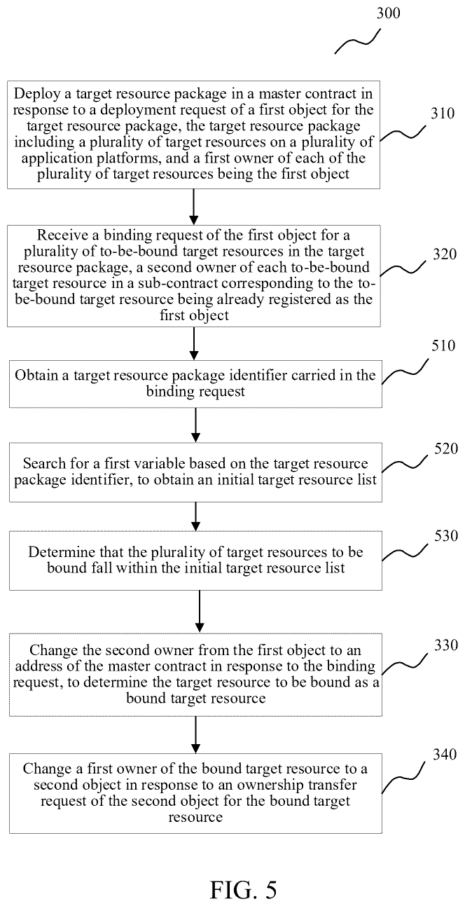

Refer to FIG. 5. After the binding request for the plurality of target resources to be bound is received in operation 320 and before the second owner is changed from the first object to the address of the master contract in operation 330, the method for processing blockchain resources may further include, but is not limited to, the following operation 510 to operation 530.

Operation 510: Obtain a target resource package identifier carried in the binding request.

Operation 520: Search for a first variable based on the target resource package identifier, to obtain an initial target resource list.

Operation 530: Determine that the plurality of target resources to be bound fall within the initial target resource list.

In operation 510, a target resource package identifier of a resource to be bound is configured in the binding request for the target resource to be bound. Based on this, the target resource package identifier carried in the binding request needs to be obtained, to determine a search index for searching for a corresponding initial target resource list.

In some embodiments, before the target resource package identifier carried in the binding request is obtained, the method for processing blockchain resources may further include: obtaining a first transmitter of the binding request, and determining the first transmitter as the first object.

Because an object delivering the binding request and an object deploying the target resource package may not be the same object, when it is determined that the target resource package is deployed by the first object, the first transmitter of the binding request may be obtained, the first transmitter is determined as the first object, and then a subsequent operation is performed. Accordingly, security of the method for processing blockchain resources in this application can be further improved.

In operation 520, in a process of deploying the target resource package, the target resource package identifier, the initial target resource list, and the first variable are recorded in the master contract on a blockchain, and a mapping relationship between the target resource package identifier and the initial target resource list is recorded in the first variable. Therefore, based on the target resource package identifier, the master contract is searched for the first variable, to obtain the initial target resource list matching the target resource package identifier.

Then, in operation 530, it may be determined that, the plurality of target resources to be bound may be found in the initial target resource list of the target resource package in the master contract.

Resources collected by the first object on different application platforms are integrated into a target resource package and deployed in the master contract. Based on this, the plurality of target resources to be bound needing to be bound fall within the initial target resource list. This means that these target resources to be bound needing to be bound may be found in the target resource package deployed in the master contract.

According to this embodiment of this application shown in operation 510 to operation 530, before a resource ownership transfer function in a sub-contract on the blockchain is invoked, it is first determined that the plurality of target resources to be bound fall within the initial target resource list, to ensure that the target resource that needs to be bound can be found in the master contract. Based on this, a second owner of the target resource to be bound in the sub-contract is subsequently changed to the address of the master contract. This helps improve accuracy and efficiency of resource binding.

In some embodiments, if a case in which the target resource to be bound does not fall within the initial target resource list exists, corresponding error information may be generated based on this case, and is fed back to the first object.

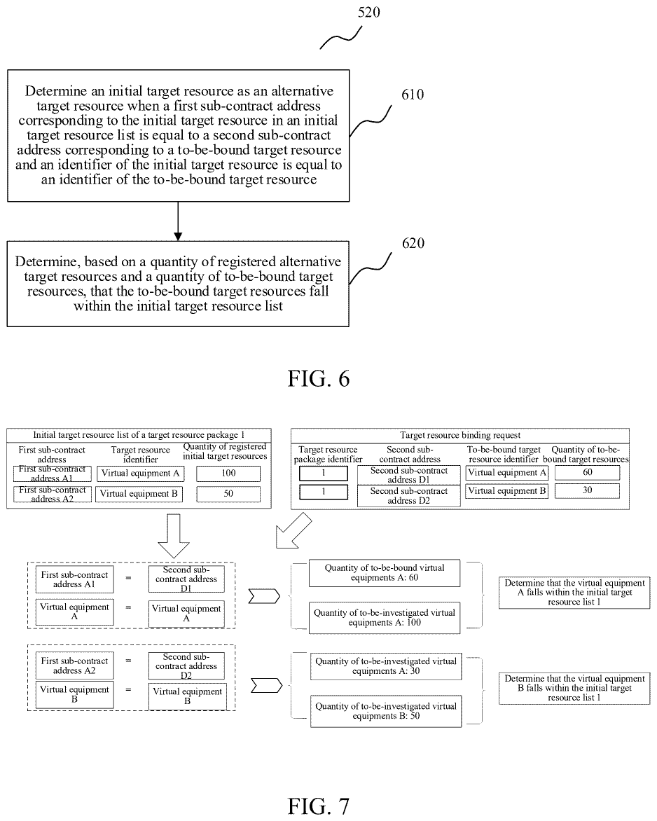

Refer to FIG. 6. An initial target resource list includes information about a plurality of initial target resources, and information about each initial target resource includes: a first sub-contract address corresponding to an application platform with which the initial target resource is registered, an identifier of the initial target resource, and a quantity of registered initial target resources on the application platform.

A binding request includes information about a plurality of target resources to be bound, and information about each target resource to be bound includes: a second sub-contract address corresponding to an application platform with which the target resource to be bound is registered, an identifier of the target resource to be bound, and a quantity of target resources to be bound.

Operation 530 may include, but is not limited to, the following operation 610 and operation 620.

Operation 610: Determine an initial target resource as an alternative target resource when a first sub-contract address corresponding to the initial target resource in an initial target resource list is equal to a second sub-contract address corresponding to a target resource to be bound, and an identifier of the initial target resource is equal to an identifier of the target resource to be bound.

Operation 620: Determine, based on a quantity of registered alternative target resources and a quantity of target resources to be bound, that the target resources to be bound fall within the initial target resource list.

In the initial target resource list, for each initial target resource, the first sub-contract address corresponding to the application platform with which the initial target resource is registered and the identifier of the initial target resource are recorded. In the binding request, for each target resource to be bound, the second sub-contract address corresponding to the application platform with which the target resource to be bound is registered and the identifier of the target resource to be bound are recorded. In this case, in operation 610, if a first sub-contract address corresponding to an initial target resource in the initial target resource list is equal to a second sub-contract address corresponding to a target resource to be bound, and an identifier of the initial target resource is equal to an identifier of the target resource to be bound, it means that the target resource to be bound falling within the initial target resource list exists. Therefore, the initial target resource may be determined as the alternative target resource.

In operation 620, when the quantity of registered alternative target resources is greater than or equal to the quantity of target resources to be bound, it may be determined that all the target resources to be bound fall within the initial target resource list. If the quantity of registered alternative target resources is less than the quantity of target resources to be bound, it may be determined that a part of the target resources to be bound fall within the initial target resource list.

There are various embodiments for determining, based on the quantity of registered alternative target resources and the quantity of target resources to be bound, that the target resources to be bound fall within the initial target resource list. These embodiments may include, but are not limited to, the specific embodiments listed above.

According to this embodiment of this application shown in operation 610 and operation 620, it is determined, based on the first sub-contract address, the identifier of the initial target resource, the quantity of registered alternative target resources, the second sub-contract address, the identifier of the target resource to be bound, and the quantity of target resources to be bound, that the target resources to be bound fall within the initial target resource list. This helps improve accuracy and efficiency of resource binding.

Refer to FIG. 7. FIG. 7 shows an example embodiment of determining that target resources to be bound fall within an initial target resource list. A binding request for the target resources to be bound includes:
a second sub-contract address D1 corresponding to an application platform with which a target resource to be bound is registered, an identifier E1 (for example, a virtual equipment A) of the target resource to be bound, and a quantity F1 (60) of target resources to be bound; and
a second sub-contract address D2 corresponding to an application platform with which a target resource to be bound is registered, an identifier E2 (for example, a virtual equipment B) of the target resource to be bound, and a quantity F2 (30) of target resources to be bound.

In this embodiment of this application, because a target resource package identifier corresponding to the binding request is 1, a first variable is searched for based on the target resource package identifier 1, to obtain an initial target resource list of the target resource package 1.

A first sub-contract address A1 corresponding to an initial target resource in the initial target resource list is equal to the second sub-contract address D1 corresponding to the target resource to be bound, and an identifier B1 (the virtual equipment A) of the initial target resource is equal to the identifier E1 (the virtual equipment A) of the target resource to be bound. In this case, the corresponding initial target resource may be determined as an alternative target resource.

It may be determined that a quantity C1 (100) of registered target resources corresponding to the identifier B1 (the virtual equipment A) is greater than the quantity F1 (60) of target resources to be bound corresponding to the identifier E1 (the virtual equipment A), and it may be determined that the target resources to be bound corresponding to the identifier E1 (the virtual equipment A) fall within the initial target resource list of the target resource package 1.

Similarly, a first sub-contract address A2 corresponding to an initial target resource in the initial target resource list is equal to the second sub-contract address D2 corresponding to the target resource to be bound and an identifier B2 (the virtual equipment B) of the initial target resource is equal to the identifier E2 (the virtual equipment B) of the target resource to be bound. In this case, the corresponding initial target resource may be determined as an alternative target resource.

It may be determined that a quantity C2 (50) of registered target resources corresponding to the identifier B2 (the virtual equipment B) is greater than the quantity F2 (30) of target resources to be bound corresponding to the identifier E2 (the virtual equipment B), and it may be determined that the target resources to be bound corresponding to the identifier E2 (the virtual equipment B) fall within the initial target resource list of the target resource package 1.

FIG. 7 shows an embodiment of determining that the target resources to be bound fall within the initial target resource list. Determining that the target resources to be bound fall within the initial target resource list may include a plurality of embodiments, and is not limited to the foregoing examples.

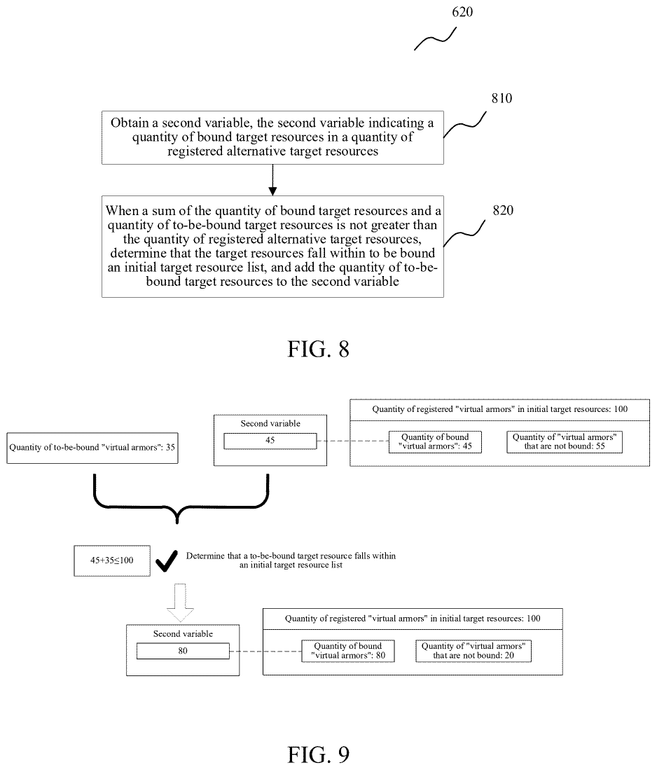

Refer to FIG. 8. Operation 620 may include, but is not limited to, the following operation 810 and operation 820.

Operation 810: Obtain a second variable, the second variable indicating a quantity of bound target resources in a quantity of registered alternative target resources.

Operation 820: When a sum of the quantity of bound target resources and a quantity of target resources to be bound is not greater than the quantity of registered alternative target resources, determine that the target resources to be bound fall within an initial target resource list, and add the quantity of target resources to be bound to the second variable.

The quantity of bound target resources refers to a quantity of bound target resources before the target resources are bound in this round. Therefore, after the second variable is obtained, it may be determined whether the sum of the quantity of bound target resources and the quantity of target resources to be bound is greater than the quantity of registered alternative target resources.

If the sum of the quantity of bound target resources and the quantity of target resources to be bound is not greater than the quantity of registered alternative target resources, it means that a quantity of resources that are not bound in the quantity of registered alternative target resources can support a binding request for a plurality of target resources to be bound. In this case, it may be determined that the target resources to be bound fall within the initial target resource list, and the quantity of target resources to be bound is added to the second variable.

Adding the quantity of target resources to be bound to the second variable specifically means adding the quantity of target resources to be bound to the quantity of bound target resources in the second variable, to update the quantity of bound target resources in the quantity of registered alternative target resources.

Accordingly, according to this embodiment of this application shown in operation 810 and operation 820, in a process of determining that the target resources to be bound fall within the initial target resource list, it may be first determined that the quantity of target resources that are not bound is greater than the quantity of target resources to be bound, to reduce occurrence of invalid resource binding processes. This helps improve accuracy and efficiency of resource binding.

FIG. 9 shows an embodiment of determining that target resources to be bound fall within an initial target resource list. In FIG. 9, whether a “virtual armor” falls within the initial target resource list needs to be determined. For this purpose, a second variable is obtained. A corresponding quantity of registered “virtual armors” in initial target resources is 100, a quantity of bound virtual armors in the registration of registered virtual armors is 45, and a quantity of virtual armors that are not bound in the corresponding quantity of registered virtual armors is 55. Therefore, the second variable indicates that the quantity of bound virtual armors in the quantity of registered virtual armors is 45.

Based on this, a quantity of “virtual armors” to be bound is 35, and a sum of the quantity 45 of bound virtual armors and the quantity 35 of virtual armors to be bound is 80, which is less than the quantity 100 of registered virtual armors. Therefore, it may be determined that the target resources to be bound fall within the initial target resource list.

Accordingly, in a process of determining that the target resources to be bound fall within the initial target resource list, it may be first determined that a quantity of target resources that are not bound is greater than a quantity of target resources to be bound, to reduce occurrence of invalid resource binding processes. This helps improve accuracy and efficiency of resource binding.

In addition, adding the quantity of virtual armors to be bound to the second variable specifically means adding the quantity 35 of virtual armors to be bound to the quantity 45 of bound virtual armors in the second variable, and updating the quantity of bound virtual armors in the second variable to 80, to update the quantity of bound “virtual armors” indicated in the second variable.

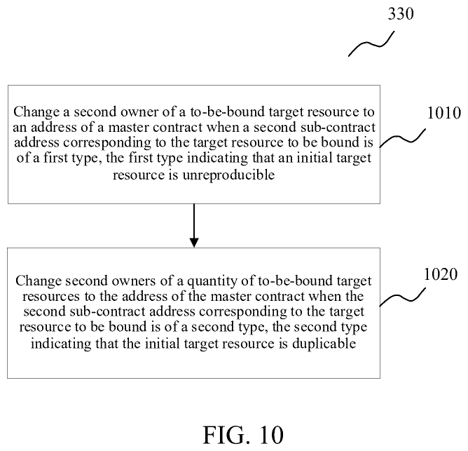

Refer to FIG. 10. For each target resource to be bound, operation 330 may include, but is not limited to, the following operation 1010 and operation 1020.

Operation 1010: Change a second owner of a target resource to be bound to an address of a master contract when a second sub-contract address corresponding to the target resource to be bound is of a first type, the first type indicating that an initial target resource is unreproducible.

Operation 1020: Change second owners of a quantity of target resources to be bound to the address of the master contract when the second sub-contract address corresponding to the target resource to be bound is of a second type, the second type indicating that the initial target resource is duplicable.

An application platform in this embodiment of this application refers to a network platform carrying a blockchain application, and a sub-contract refers to a service contract for storing virtual resources in the application platform. On the application platform, specific data processing may be performed on the virtual resources according to some data protocol standards, making these virtual resources unique and irreplaceable. According to different data protocol standards, types of specific data processing performed on the virtual resources also vary.

Therefore, based on differences between data protocol standards followed by different sub-contracts, the sub-contract address may be of the first type or the second type. In an initial target resource list, the first type indicates that the initial target resource is unreproducible, and the second type indicates that the initial target resource is duplicable.

In operation 1010, the first type indicates that the initial target resource is unreproducible, which means that a quantity of initial target resources of the first type is limited to 1 or 0. In this case, the second owner of the target resource to be bound is directly changed to the address of the master contract, so that binding of the target resource can be completed.

In operation 1020, the second type indicates that the initial target resource is duplicable, which means that a quantity of initial target resources of the second type is not limited to 1. In this case, the quantity of target resources to be bound is determined, and then the second owners of the quantity of target resources to be bound are changed to the address of the master contract, so that binding of the target resources can be completed.

According to this embodiment of this application shown in operation 1010 and operation 1020, based on the type of the second sub-contract address, the second owners of the quantity of target resources to be bound are changed to the address of the master contract. Accordingly, differences between data protocol standards of different application platforms can be flexibly dealt with.

Even if a part of a plurality of application platforms that store virtual resources are of the first type and a part of the application platforms are of the second type, and it is difficult to integrate the virtual resources stored in these different platforms, according to this embodiment of this application shown in operation 1010 and operation 1020, the second owners of the quantity of target resources to be bound in the target resources to be bound are changed to the address of the master contract based on the type of the second sub-contract address, the sub-contract is bound to the master contract, and a second owner of the sub-contract is linked to a first owner of the master contract, so that an operation of scheduling or transferring resources at one time by changing the first owner of the master contract is subsequently implemented. Accordingly, it is unnecessary to perform complex changes on the application platforms. This improves resource transfer and scheduling efficiency and interoperability across the application platforms.

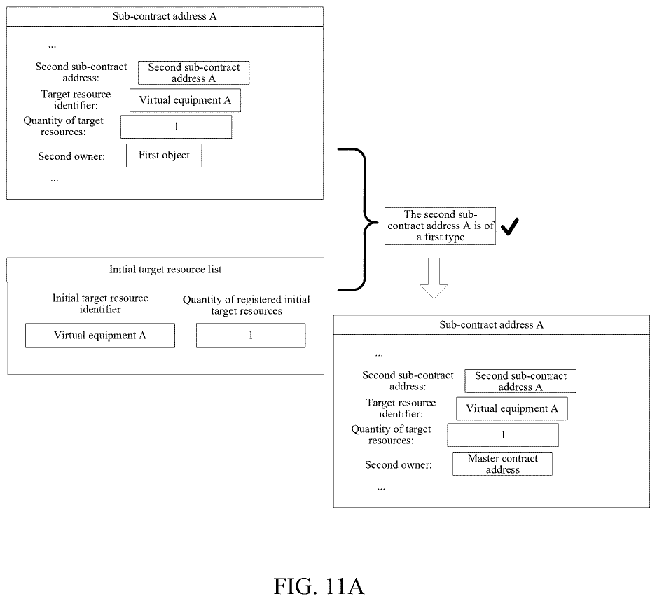

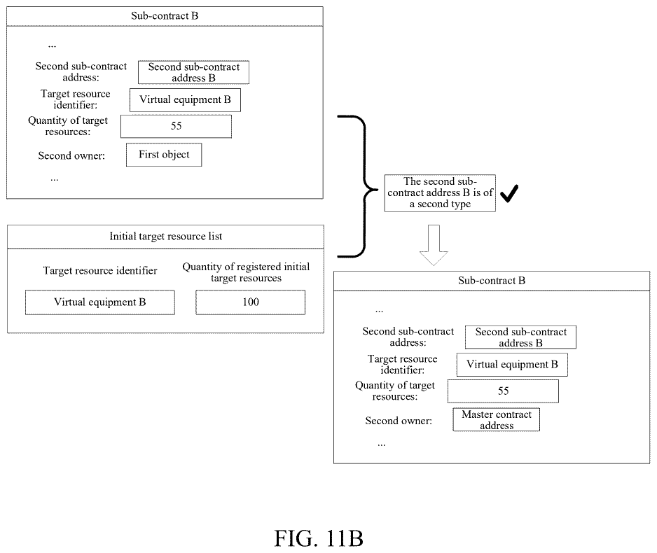

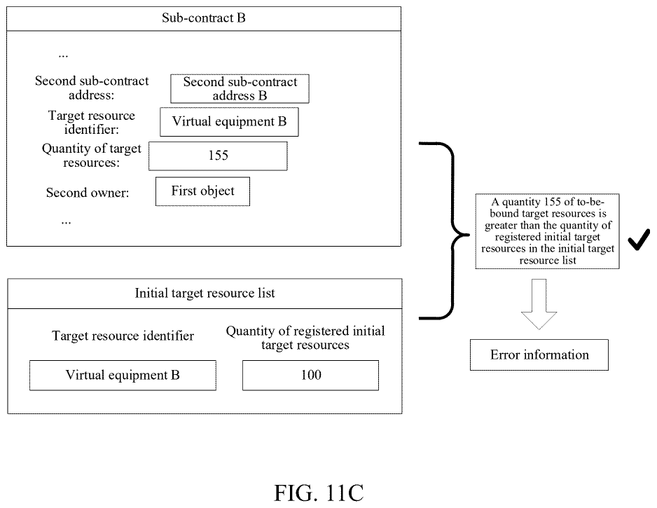

Refer to FIG. 11A. Before a target resource is bound, a virtual equipment A of a first type is stored in a sub-contract A corresponding to a second sub-contract address A. Because the first type indicates that an initial target resource is unreproducible, a quantity of target resources to be bound corresponding to the virtual equipment A can only be 1, as shown in an initial target resource list.

A second owner of the virtual equipment A is registered as a first object in the sub-contract A. The second sub-contract address A of the virtual equipment A is of the first type, and the first type indicates that the virtual equipment A is unreproducible. Therefore, the second owner of the virtual equipment A may be changed to an address of a master contract.

Refer to FIG. 11B. A virtual equipment B of a second type is stored in a sub-contract B corresponding to a second sub-contract address B. Because the second type indicates that an initial target resource is duplicable, a quantity of target resources to be bound corresponding to the virtual equipment B is not limited to 1. In the embodiment in FIG. 11B, the quantity of target resources to be bound corresponding to the virtual equipment B is 55. Second owners of the 55 target resources to be bound of the virtual equipment B are all registered as a first object in the sub-contract B. The second sub-contract address B of the virtual equipment B is of the second type, and the second type indicates that the virtual equipment B is duplicable. Therefore, the second owners of the 55 target resources to be bound of the virtual equipment B may be all changed to the address of the master contract.

Refer to FIG. 11C. A virtual equipment B of a second type is stored in a sub-contract B corresponding to a second sub-contract address B. Because an initial target resource of the second type is duplicable, a quantity of target resources to be bound corresponding to the virtual equipment B is not limited to 1. In the embodiment in FIG. 11B, the quantity of target resources to be bound corresponding to the virtual equipment B is 155. It may be learned that the quantity 155 of target resources to be bound is greater than a quantity 100 of registered target resources in an initial target resource list. In this case, corresponding error information is generated, and is fed back to a first object.

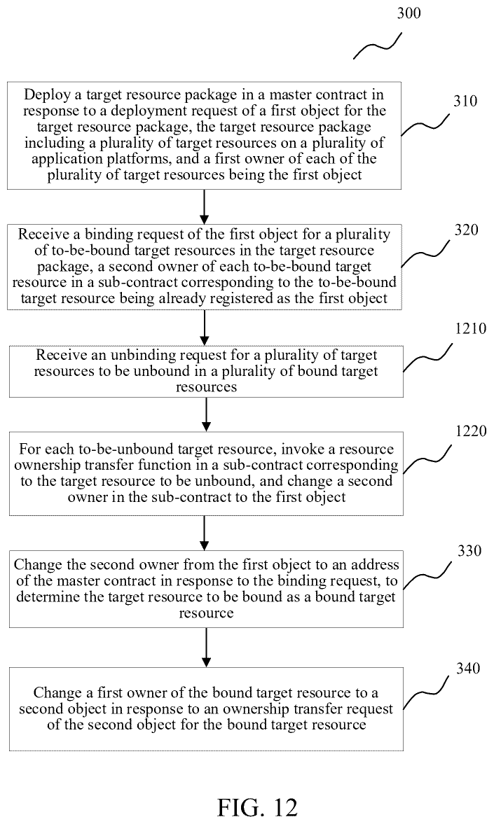

Refer to FIG. 12. After operation 330, the method for processing blockchain resources in this application may further include, but is not limited to, the following operation 1210 and operation 1220.

Operation 1210: Receive an unbinding request for a plurality of target resources to be unbound in a plurality of bound target resources.

Operation 1220: For each target resource to be unbound, invoke a resource ownership transfer function in a sub-contract corresponding to the target resource to be unbound, and change a second owner in the sub-contract to the first object.

In this embodiment of this application, in a process of determining a target resource to be bound as a bound target resource, there may be cases such as a binding error and a binding solution needing to be adjusted. Therefore, after a batch of target resources are bound, a part or all of the target resources may be unbound, thereby improving flexibility of resource scheduling or transfer.

In this embodiment of this application, the resource ownership transfer function is configured in the sub-contract, to adjust a resource ownership right on the sub-contract. When the cases such as the binding error and the binding solution needing to be adjusted occur, a part or all of the plurality of bound target resources need to be unbound. Therefore, first, the unbinding request for the plurality of target resources to be unbound in the plurality of bound target resources needs to be received. Based on this, the resource ownership transfer function in the sub-contract on a blockchain is invoked, so that the second owner of the target resource to be unbound in the sub-contract is changed back to the first object. Accordingly, a part or all of the plurality of bound target resources may be unbound, thereby improving flexibility of resource scheduling or transfer.

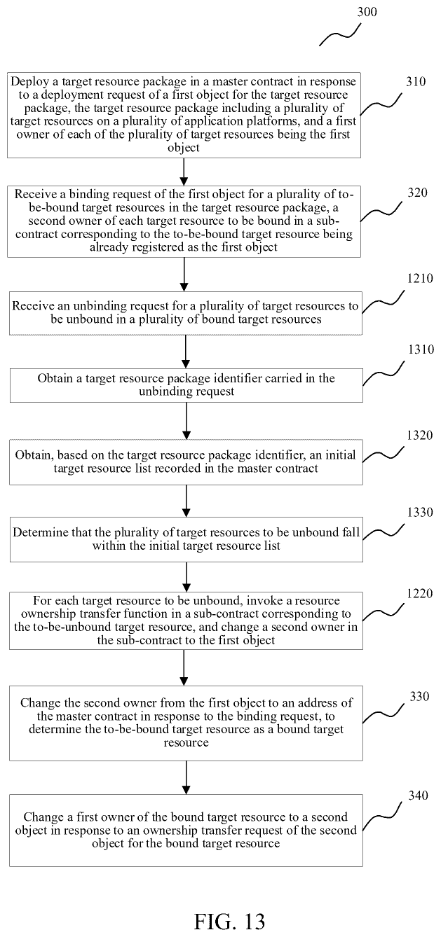

Refer to FIG. 13. Before operation 1220, the method for processing blockchain resources in this application may further include, but is not limited to, the following operation 1310 to operation 1330.

Operation 1310: Obtain a target resource package identifier carried in the unbinding request. A target resource package identifier of a resource to be unbound is configured in the unbinding request for a target resource to be unbound. Based on this, the target resource package identifier carried in the unbinding request is obtained, to determine a search index for searching a corresponding initial target resource list.

In some embodiments, before the target resource package identifier carried in the unbinding request is obtained, the method for processing blockchain resources may further include: obtaining a second transmitter of the unbinding request, and determining the second transmitter as a first object.

Because an object delivering the unbinding request, an object delivering the binding request, and an object deploying a target resource package may not be the same object, when it is determined that the target resource package is deployed by the first object, the second transmitter of the unbinding request may be obtained, the second transmitter is determined as the first object, and then a subsequent operation is performed. Accordingly, security of the method for processing blockchain resources in this application can be further improved.

Operation 1320: Obtain, based on the target resource package identifier, an initial target resource list recorded in the master contract.

In this embodiment of this application, in a process of deploying the target resource package, the target resource package identifier, the initial target resource list, and a first variable are recorded in the master contract on a blockchain, and a mapping relationship between the target resource package identifier and the initial target resource list is recorded in the first variable. Therefore, based on the target resource package identifier, the master contract is searched for the first variable, to obtain the initial target resource list matching the target resource package identifier.

Operation 1330: Determine that the plurality of target resources to be unbound fall within the initial target resource list.

Determining that the plurality of target resources to be unbound fall within the initial target resource list means that these target resources to be unbound needing to be unbound may be found in the target resource package deployed in the master contract.

According to this embodiment of this application shown in operation 1310 to operation 1330, before a resource ownership transfer function in a sub-contract on the blockchain is invoked, it is first determined that the plurality of target resources to be unbound fall within the initial target resource list, to ensure that the target resource needing to be unbound can be found in the master contract. Based on this, a second owner of the target resource to be unbound in the sub-contract is subsequently changed back to the first object. This helps improve accuracy and efficiency of resource unbinding.

In some embodiments, if a case in which the target resource to be unbound does not fall within the initial target resource list exists, corresponding error information may be generated based on this case, and is fed back to the first object.

In some example embodiments, the initial target resource list includes information about a plurality of initial target resources, and information about each initial target resource includes: a first sub-contract address corresponding to an application platform with which the initial target resource is registered, an identifier of the initial target resource, and a quantity of registered initial target resources on the application platform. The unbinding request includes information about the plurality of target resources to be unbound, and information about each target resource to be unbound includes: a third sub-contract address corresponding to an application platform with which the target resource to be unbound is registered and an identifier of the target resource to be unbound.

Operation 1330 may include, but is not limited to: Determine that a target resource to be unbound falls within the initial target resource list when a first sub-contract address corresponding to an initial target resource in the initial target resource list is equal to a third sub-contract address corresponding to the target resource to be unbound, and an identifier of the initial target resource is equal to an identifier of the target resource to be unbound.

In this embodiment of this application, in the initial target resource list, for each initial target resource, the first sub-contract address corresponding to the application platform with which the initial target resource is registered and the identifier of the initial target resource are recorded; and in the unbinding request, for each target resource to be unbound, the third sub-contract address corresponding to the application platform with which the target resource to be unbound is registered and the identifier of the target resource to be unbound are recorded. In this case, if a first sub-contract address corresponding to an initial target resource in the initial target resource list is equal to a third sub-contract address corresponding to a target resource to be unbound, and an identifier of the initial target resource is equal to an identifier of the target resource to be unbound, it means that the target resource to be unbound falling within the initial target resource list exists. Therefore, the initial target resource may be determined as an alternative target resource. In the foregoing manner, it is determined that the target resource to be unbound falls within the initial target resource list. This helps improve accuracy and efficiency of resource unbinding.

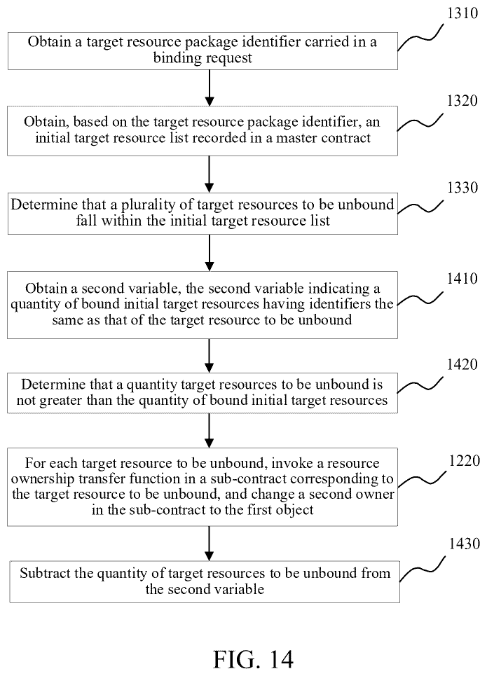

Refer to FIG. 14. An unbinding request further carries a quantity of target resources to be unbound. After operation 1330, for each target resource to be unbound, the method for processing blockchain resources may further include, but is not limited to, the following operations.

Operation 1410: Obtain a second variable, the second variable indicating a quantity of bound initial target resources having identifiers the same as that of the target resource to be unbound.

Operation 1420: Determine that a quantity target resources to be unbound is not greater than the quantity of bound initial target resources.

The quantity of bound initial target resources herein refers to a quantity of bound initial target resources before the target resources are unbound in this round. Therefore, after the second variable is obtained, whether the quantity of target resources to be unbound is not greater than the second variable, namely, the quantity of bound target resources before the target resources are unbound in this round, may be determined based on the quantity of bound target resources and the quantity of target resources to be unbound. If the quantity of target resources to be unbound is not greater than the second variable, it means that the quantity of bound target resources can support an unbinding request for unbinding all or a part of the target resources. In this case, it may be determined that the target resource to be unbound falls within an initial target resource list.

Operation 1430: Subtract the quantity of target resources to be unbound from the second variable.

After a resource ownership transfer function in a sub-contract on a blockchain is invoked to enable a second owner of the target resource to be unbound in the sub-contract to be changed to a first object, it may be determined that the quantity of bound target resources needs to be changed. Therefore, a response to the unbinding request may be completed by subtracting the quantity of target resources to be unbound from the second variable.

Accordingly, according to this embodiment of this application shown in operation 1410 to operation 1430, it may be first determined that the quantity of target resources to be unbound is greater than the quantity of bound target resources before the resource ownership transfer function in the sub-contract on the blockchain is invoked to unbind the target resource, to reduce occurrence of invalid resource unbinding processes. This helps improve accuracy and efficiency of resource unbinding.

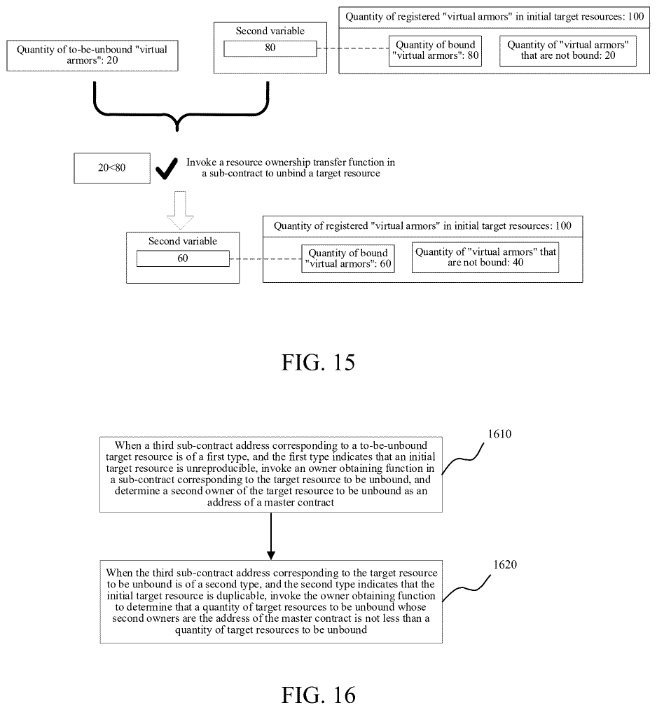

FIG. 15 shows an embodiment of unbinding a target resource after determining that a target resource to be unbound falls within an initial target resource list. In FIG. 15, unbinding needs to be performed for 80 bound “virtual armors” to unbind 20 “virtual armors” from the “virtual armors”. In view of this, a second variable needs to be first obtained, and the second variable indicates a quantity 80 of bound initial target resources.

Then, it is determined that a quantity 20 of virtual armors to be unbound is less than the second variable 80.

Further, a resource ownership transfer function in a sub-contract on a blockchain is invoked, so that a second owner of the target resource to be unbound in the sub-contract is changed to a first object.

Further, the quantity 20 of virtual armors to be unbound is subtracted from the second variable 80.

Accordingly, it may be first determined that a quantity of target resources to be unbound is greater than a quantity of bound target resources before the resource ownership transfer function in the sub-contract on the blockchain is invoked to unbind the target resource, to reduce occurrence of invalid resource unbinding processes. This helps improve accuracy and efficiency of resource unbinding.

Refer to FIG. 16. An unbinding request further carries a quantity of target resources to be unbound. After operation 1330, for each target resource to be unbound, the method for processing blockchain resources may further include, but is not limited to, the following operation 1610 and operation 1620.

Operation 1610: When a third sub-contract address corresponding to a target resource to be unbound is of a first type, and the first type indicates that an initial target resource is unreproducible, invoke an owner obtaining function in a sub-contract corresponding to the target resource to be unbound, and determine a second owner of the target resource to be unbound as an address of a master contract.

The first type indicates that the initial target resource is unreproducible, which means that a quantity of bound target resources of the first type is limited to 1 or 0. In this case, the owner obtaining function in the sub-contract on a blockchain may be invoked, to determine the second owner of the target resource to be unbound in the sub-contract as the address of the master contract.

Further, the second owner of the target resource to be unbound is changed back to a first object, so that the target resource can be unbound.

Operation 1620: When the third sub-contract address corresponding to the target resource to be unbound is of a second type, and the second type indicates that the initial target resource is duplicable, invoke the owner obtaining function to determine that a quantity of target resources to be unbound whose second owners are the address of the master contract is not less than a quantity of target resources to be unbound.

The second type indicates that the initial target resource is duplicable, which means that a quantity of bound target resources of the second type is not limited to 1. In this case, the owner obtaining function in the sub-contract on the blockchain needs to be invoked, to determine that the quantity of target resources that are on the application platform corresponding to sub-contracts and whose second owners are the address of the master contract is not less than the quantity of target resources to be unbound.

Further, the second owners of the quantity of target resources to be unbound are changed back to the first object, so that the target resource can be unbound.

According to this embodiment of this application shown in operation 1610 and operation 1620, based on the type of the third sub-contract address, the second owners of the quantity of target resources to be unbound are changed to the first object. Accordingly, differences between data protocol standards of different application platforms can be flexibly dealt with. Even if a part of a plurality of application platforms that store virtual resources are of the first type and a part of the application platforms are of the second type, and it is difficult to integrate the virtual resources stored in these different platforms, according to this embodiment of this application shown in operation 1610 and operation 1620, the second owners of the quantity of target resources to be unbound may be changed back to the first object based on the type of the third sub-contract address, to implement unbinding of the target resources on the different application platforms at one time. Accordingly, it is unnecessary to perform complex changes on the application platforms. This improves resource transfer and scheduling efficiency and interoperability across the application platforms.

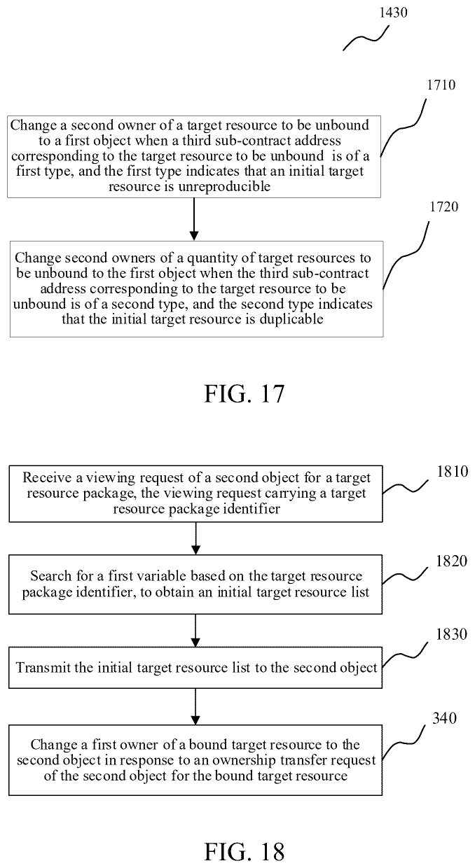

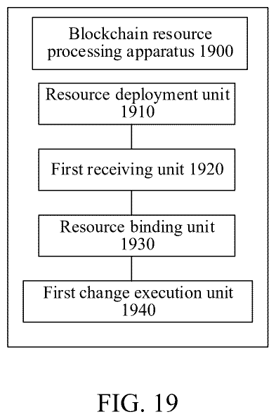

Refer to FIG. 17. In operation 1430, invoking the ownership transfer function in the sub-contract corresponding to the target resource to be unbound to change the second owner in the sub-contract to the first object may include, but is not limited to, the following operation 1710 and operation 1720.

Operation 1710: Change a second owner of a target resource to be unbound to a first object when a third sub-contract address corresponding to the target resource to be unbound is of a first type, and the first type indicates that an initial target resource is unreproducible.

The first type indicates that the initial target resource is unreproducible, which means that a quantity of initial target resources of the first type is limited to 1 or 0. When it is determined that the third sub-contract address corresponding to the target resource to be unbound is of the first type, the second owner of the target resource to be unbound is changed to an address of a master contract, so that the target resource can be unbound.

Operation 1720: Change second owners of a quantity of target resources to be unbound to the first object when the third sub-contract address corresponding to the target resource to be unbound is of a second type, and the second type indicates that the initial target resource is duplicable.

The second type indicates that the initial target resource is duplicable, which means that a quantity of initial target resources of the second type is not limited to 1. When it is determined that the third sub-contract address corresponding to the target resource to be unbound is of the second type, the second owners of the quantity of target resources to be unbound need to be changed to the first object.

Accordingly, according to this embodiment of this application shown in operation 1710 and operation 1720, the second owners of the quantity of target resources to be unbound may be changed from the address of the master contract back to the first object, to unbind the target resources. This reflects flexibility of master scheduling or transfer of information about the target resources.

Refer to FIG. 18. Before operation 340, the method for processing blockchain resources may further include, but is not limited to, the following operation 1810 and operation 1820.

Operation 1810: Receive a viewing request of a second object for a target resource package, the viewing request carrying a target resource package identifier.

Operation 1820: Search for a first variable based on the target resource package identifier, to obtain an initial target resource list.

Operation 1830: Transmit the initial target resource list to the second object.

Before a first owner of a bound target resource is changed to the second object in response to a target resource ownership transfer request of the second object, the second object needs to confirm ownership of a resource corresponding to the target resource ownership transfer request. Therefore, this embodiment of this application provides implementations shown in operation 1810 to operation 1830, to achieve the effect.

In operation 1810, a target resource package identifier of a resource to be viewed is configured in the viewing request for the target resource package. Based on this, the target resource package identifier of the viewing request needs to be obtained, to determine a search index for searching for a corresponding initial target resource list.

In some embodiments, before the target resource package identifier of the viewing request is obtained, the method for processing blockchain resources may further include: obtaining a third transmitter of the viewing request, and determining the third transmitter as the second object. Because an object delivering the viewing request and a target object transferring the target resource package may not be the same object, when the second object is determined as the target object transferring the resource, the third transmitter of the viewing request may be obtained, the third transmitter is determined as the second object, and then a subsequent operation is performed. Accordingly, security of the method for processing blockchain resources in this application can be further improved.

In operation 1820, in a process of deploying the target resource package, the target resource package identifier, the initial target resource list, and the first variable are recorded in a master contract on a blockchain, and a mapping relationship between the target resource package identifier and the initial target resource list is recorded in the first variable. Therefore, based on the target resource package identifier, the master contract is searched for the first variable, to obtain the initial target resource list matching the target resource package identifier.

In operation 1830, a plurality of target resources to be viewed may be found in the initial target resource list of the target resource package in the master contract. This means that resources needing to be viewed by the second object are integrated by the first object into the target resource package and deployed in the master contract. Based on this, the plurality of target resources to be viewed needing to be viewed fall within the initial target resource list. Therefore, the initial target resource list may be transmit to the second object, so that the second object confirms the ownership of the resource corresponding to the target resource ownership transfer request. Accordingly, security of the method for processing blockchain resources in this application can be further improved.

According to an aspect of this application, a blockchain resource processing apparatus 1900 is provided. The blockchain resource processing apparatus 1900 corresponds to a blockchain node. The blockchain node is connected to a plurality of application platforms, and maintains, on a blockchain, a sub-contract configured for each application platform and a master contract configured for the plurality of application platform. The apparatus 1900 includes:
a resource deployment unit 1910, configured to deploy a target resource package in the master contract in response to a deployment request of a first object for the target resource package, the target resource package including a plurality of target resources on the plurality of application platforms, and a first owner of each of the plurality of target resources being the first object;
a first receiving unit 1920, configured to receive a binding request of the first object for a plurality of target resources to be bound in the target resource package, a second owner of each target resource to be bound in a sub-contract corresponding to the target resource to be bound being already registered as the first object;
a resource binding unit 1930, configured to change the second owner from the first object to an address of the master contract in response to the binding request, to determine the target resource to be bound as a bound target resource; and
a first change execution unit 1940, configured to change a first owner of the bound target resource to a second object in response to an ownership transfer request of the second object for the bound target resource.

In some embodiments, the resource deployment unit 1910 is specifically configured to:
allocate a target resource package identifier to the target resource package in response to the deployment request;
receive an initial target resource list of the target resource package;
record a mapping relationship between the target resource package identifier and the initial target resource list in a first variable; and
record the target resource package identifier, the initial target resource list, and the first variable in the master contract.

In some embodiments, the blockchain resource processing apparatus 1900 further includes:
a first obtaining unit (not shown), configured to obtain the target resource package identifier carried in the binding request before the second owner is changed from the first object to the address of the master contract;
a first searching unit (not shown), configured to search for the first variable based on the target resource package identifier, to obtain the initial target resource list; and
a first determining unit (not shown), configured to determine that the plurality of target resources to be bound fall within the initial target resource list.

In some embodiments, the initial target resource list includes information about a plurality of initial target resources, and information about each initial target resource includes: a first sub-contract address corresponding to an application platform with which the initial target resource is registered, an identifier of the initial target resource, and a quantity of registered initial target resources on the application platform.

The binding request includes information about the plurality of target resources to be bound, and information about each target resource to be bound includes: a second sub-contract address corresponding to an application platform with which the target resource to be bound is registered, an identifier of the target resource to be bound, and a quantity of target resources to be bound.

The first determining unit is specifically configured to:
determine an initial target resource as an alternative target resource when a first sub-contract address corresponding to the initial target resource in the initial target resource list is equal to a second sub-contract address corresponding to a target resource to be bound and an identifier of the initial target resource is equal to an identifier of the target resource to be bound; and
determine, based on the quantity of registered alternative target resources and the quantity of target resources to be bound, that the target resources to be bound fall within the initial target resource list.

In some embodiments, the first determining unit is specifically configured to:
obtain a second variable, the second variable indicating a quantity of bound target resources in the quantity of registered alternative target resources; and
when a sum of the quantity of bound target resources and the quantity of target resources to be bound is not greater than the quantity of registered alternative target resources, determine that the target resources to be bound fall within the initial target resource list, and add the quantity of target resources to be bound to the second variable.

In some embodiments, the apparatus 1900 further includes:
a second determining unit (not shown), configured to determine that the first sub-contract address corresponding to the initial target resource is of a first type after the initial target resource list is obtained, the first type indicating that the initial target resource is unreproducible; and

a first verification unit (not shown), configured to verify that the quantity of registered initial target resources is 1.

In some embodiments, the resource binding unit 1930 is specifically configured to:
for each target resource to be bound,
change the second owner of the target resource to be bound to the address of the master contract when the second sub-contract address corresponding to the target resource to be bound is of a first type, and the first type indicates that the initial target resource is unreproducible; and
change second owners of the quantity of target resources to be bound to the address of the master contract when the second sub-contract address corresponding to the target resource to be bound is of a second type, and the second type indicates that the initial target resource is duplicable.

In some embodiments, the blockchain resource processing apparatus 1900 further includes:
a second obtaining unit (not shown), configured to obtain a first transmitter of the binding request before the target resource package identifier carried in the binding request is obtained; and
a third determining unit (not shown), configured to determine the first transmitter as the first object.

In some embodiments, the apparatus 1900 further includes:
a second receiving unit (not shown), configured to receive an unbinding request for a plurality of target resources to be unbound in a plurality of bound target resources; and
a second change execution unit (not shown), configured to: for each target resource to be unbound, invoke a resource ownership transfer function in a sub-contract corresponding to the target resource to be unbound, and change a second owner in the sub-contract to the first object.

In some embodiments, the apparatus 1900 further includes:
a third obtaining unit (not shown), configured to obtain the target resource package identifier carried in the unbinding request before the second owner in the sub-contract is changed to the first object;
a first searching unit (not shown), configured to obtain the initial target resource list recorded in the master contract based on the target resource package identifier; and
a fourth determining unit (not shown), configured to determine that the plurality of target resources to be unbound fall within the initial target resource list.

In some embodiments, the initial target resource list includes the information about the plurality of initial target resources, and the information about each initial target resource includes: the first sub-contract address corresponding to the application platform with which the initial target resource is registered, the identifier of the initial target resource, and the quantity of registered initial target resources on the application platform.

The unbinding request includes information about the plurality of target resources to be unbound, and information about each target resource to be unbound includes: a third sub-contract address corresponding to an application platform with which the target resource to be unbound is registered and an identifier of the target resource to be unbound.

The fourth determining unit (not shown) is specifically configured to:
determine that a target resource to be unbound falls within the initial target resource list when a first sub-contract address corresponding to an initial target resource in the initial target resource list is equal to a third sub-contract address corresponding to the target resource to be unbound, and an identifier of the initial target resource is equal to an identifier of the target resource to be unbound.

In some embodiments, the unbinding request further carries a quantity of target resources to be unbound.

The apparatus 1900 further includes:
a fourth obtaining unit, configured to obtain a second variable, the second variable indicating a quantity of bound initial target resources having identifiers the same as that of the target resource to be unbound;
a fifth determining unit (not shown), configured to determine that the quantity of target resources to be unbound is not greater than the quantity of bound initial target resources; and
a resource unbinding unit (not shown), configured to subtract the quantity of target resources to be unbound from the second variable.

In some embodiments, the unbinding request further carries a quantity of target resources to be unbound; and
for each target resource to be unbound, the apparatus 1900 further includes:
an owner address determining unit (not shown), configured to: when the third sub-contract address corresponding to the target resource to be unbound is of the first type, and the first type indicates that the initial target resource is unreproducible, invoke an owner obtaining function in the sub-contract corresponding to the target resource to be unbound, and determine that the second owner of the target resource to be unbound as the address of the master contract; and
an owner quantity determining unit (not shown), configured to: when the third sub-contract address corresponding to the target resource to be unbound is of the second type, and the second type indicates that the initial target resource is duplicable, invoke the owner obtaining function to determine that a quantity of target resources to be unbound whose second owners are the address of the master contract is not less than the quantity of target resources to be unbound.

In some embodiments, the apparatus 1900 further includes:
a fifth obtaining unit (not shown), configured to obtain a second transmitter of the unbinding request before the target resource package identifier carried in the unbinding request is obtained; and
a sixth determining unit (not shown), configured to determine the second transmitter as the first object.

In some embodiments, the unbinding request further carries a quantity of target resources to be unbound; and

the resource unbinding unit (not shown) is specifically configured to:
change the second owner of the target resource to be unbound to the first object when the third sub-contract address corresponding to the target resource to be unbound is of the first type, and the first type indicates that the initial target resource is unreproducible; and
change second owners of the quantity of target resources to be unbound to the first object when the third sub-contract address corresponding to the target resource to be unbound is of the second type, and the second type indicates that the initial target resource is duplicable.

In some embodiments, the apparatus 1900 further includes:
an authorization function invoking unit (not shown), configured to invoke authorization functions in a plurality of sub-contracts; and
an authorization function execution unit (not shown), configured to execute the authorization functions to authorize the master contract to access the sub-contract, so that the address of the master contract can serve as the second owner registered on the application platform corresponding to the sub-contract.

In some embodiments, the apparatus 1900 further includes:
a third receiving unit (not shown), configured to receive a viewing request of the second object for the target resource package before the first owner of the bound target resource is changed to the second object, the viewing request carrying the target resource package identifier; and
a second searching unit (not shown), configured to search for the first variable based on the target resource package identifier, to obtain the initial target resource list; and
a list transmitting unit (not shown), configured to transmit the initial target resource list to the second object.

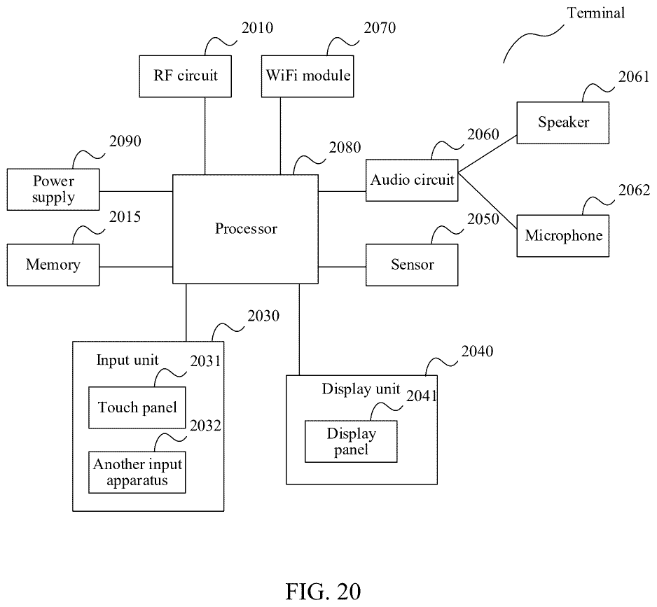

Refer to FIG. 20. FIG. 20 is a block diagram of a partial structure of a terminal that implements a method for processing blockchain resources according to an embodiment of this application. The terminal includes components such as a radio frequency (RF) circuit 2010, a memory 2015, an input unit 2030, a display unit 2040, a sensor 2050, an audio circuit 2060, a wireless fidelity (WiFi) module 2070, a processor 2080, and a power supply 2090. A person skilled in the art may understand that the structure of the terminal shown in FIG. 20 does not constitute a limitation on a mobile phone or a computer, and the terminal may include more components or fewer components than those shown in the figure, or some of the components may be combined, or a different component deployment may be used.

The RF circuit 2010 may be configured to receive and send a signal in an information receiving and sending process or a conversation process. Specifically, the RF circuit 2010 receives downlink information from a base station, then delivers the downlink information to the processor 2080 for processing, and sends related uplink data to the base station.

The memory 2015 may be configured to store a software program and module. The processor 2080 runs the software program and module stored in the memory 2015, to implement various functional applications and data processing of the object terminal.

The input unit 2030 may be configured to: receive inputted digit or character information, and generate a keyboard signal input related to settings and function control of the object terminal. Specifically, the input unit 2030 may include a touch panel 2031 and another input apparatus 2032.

The display unit 2040 may be configured to display inputted or provided information and various menus of the object terminal. The display unit 2040 may include a display panel 2041.

The audio circuit 2060, a speaker 2061, and a microphone 2062 may provide audio interfaces.

In this embodiment, the processor 2080 included in the terminal may perform the method for processing blockchain resources in the foregoing embodiments.

The terminal in the embodiments of this application may include, but not limited to, a mobile phone, a computer, a smart voice interaction device, a smart home appliance, an in-vehicle terminal, an aircraft, and the like. The embodiments of this application can be applied to various fields, including, but not limited to, a consortium blockchain, structured information processing, security technologies, data security, data storage, information technologies, and the like.

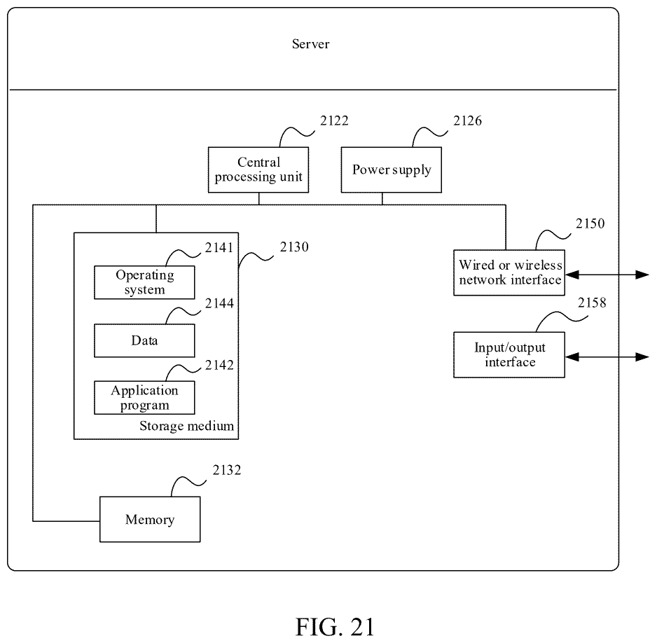

FIG. 21 is a diagram of a partial structure of a server that implements a method for processing blockchain resources according to an embodiment of this application. The server may vary significantly due to different configuration or performance, and may include one or more central processing units (CPUs) 2122 (for example, one or more processors), a memory 2132, and one or more storage media 2130 (for example, one or more mass storage apparatuses) for storing an application program 2142 or data 2144. The memory 2132 and the storage medium 2130 may be transient or persistent storages. The program stored in the storage medium 2130 may include one or more modules (not marked in the figure), and each module may include a series of instruction operations for the server. Further, the central processing unit 2122 may be configured to communicate with the storage medium 2130, and perform, on the server, the series of instruction operations in the storage medium 2130.

The server may further include one or more power supplies 2126, one or more wired or wireless network interfaces 2150, one or more input/output interfaces 2158, and/or one or more operation systems 2141, for example, Windows Server™, Mac OS X™, Unix™, Linux™, and FreeBSD™.

The central processing unit 2122 included in the server may be configured to perform the method for processing blockchain resources in the embodiments of this application.

An embodiment of this application further provides a computer-readable storage medium, configured to store program code. The program code is configured for performing the method for processing blockchain resources in the foregoing embodiments.

An embodiment of this application further provides a computer program product, including a computer program. A processor of a computer device reads and executes the computer program, to enable the computer device to perform the foregoing method for processing blockchain resources.

In the specification and accompanying drawings of this application, the terms “first”, “second”, “third”, “fourth”, and so on (if existent) are intended to distinguish between similar objects but do not necessarily indicate a specific order or sequence. Data used accordingly is exchangeable in a proper case, so that the embodiments of this application described herein can be implemented in an order different from the order shown or described herein. In addition, the terms “include” and “have” and any other variants are intended to cover the non-exclusive inclusion. For example, a process, method, system, product, or apparatus that includes a list of operations or units is not necessarily limited to those expressly listed operations or units, but may include other operations or units not expressly listed or inherent to such a process, method, product, or apparatus.

In this application, “at least one” refers to one or more, and “a plurality of” refers to two or more. The term “and/or” is configured for describing an association between associated objects and representing that three associations may exist. For example, “A and/or B” may indicate three cases: Only A exists, only B exists, and both A and B exist, and A and B may be singular or plural. The character “/” generally indicates an “or” relationship between the associated objects. “At least one of the following” or a similar expression thereof refers to any combination of these items, including one item or any combination of a plurality of items. For example, at least one of a, b, or c may represent a, b, c, “a and b”, “a and c”, “b and c”, or “a, b, and c”, and a, b, and c may be singular or plural.

In the descriptions of the embodiments of this application, “a plurality of (or multiple)” means two or more; “greater than”, “less than”, “exceed”, and the like are understood as excluding a number itself; and “above”, “below”, “within”, and the like are understood as including a number itself.

In the several embodiments provided in this application, the disclosed system, apparatus, and method may be implemented in other manners. For example, the described apparatus embodiments are merely schematic. For example, the unit division is merely logical function division and may be other division in various embodiments. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and components displayed as units may or may not be physical units, that is, may be located in one position, or may be distributed on a plurality of network units. A part or all of the units may be selected based on the objectives of the solutions of the embodiments.

In addition, the functional units in the embodiments of this application may be integrated into one processing unit, or each of the units may be physically separated, or two or more units may be integrated into one unit. The integrated unit may be implemented in the form of hardware, or may be implemented in a form of a software functional unit.

When the integrated unit is implemented in the form of a software functional unit and sold or used as an independent product, the integrated unit may be stored in a computer-readable storage medium. Based on such an understanding, the technical solutions of this application essentially, or the part contributing to the related technology, or all or a part of the technical solutions may be implemented in a form of a software product. The computer software product is stored in a storage medium and includes several instructions for indicating a computer apparatus (which may be a personal computer, a server, or a network apparatus) to perform all or a part of the operations of the methods described in the embodiments of this application. The foregoing storage medium includes: any medium that can store program code, such as a USB flash disk, a removable hard disk, a read-only memory (ROM), a random access memory (RAM), a magnetic disk, or an optical disc.

The implementations provided in the embodiments of this application may also be randomly combined to achieve different technical effects.

The foregoing is specific descriptions of the implementations of this application, but this application is not limited to the foregoing implementations. A person skilled in the art may make various equivalent variations or replacements without departing from the spirit of this application. These equivalent variations or replacements are all included in the scope defined by the claims of this application.

What is claimed is:

1. A method for processing blockchain resources, performed by an electronic device, the electronic device corresponding to a blockchain node; the blockchain node being connected to a plurality of application platforms, and maintaining a sub-contract configured for each application platform and a master contract configured for the plurality of application platform on a blockchain; and the method comprising:
deploying a target resource package in the master contract in response to a deployment request of a first object for the target resource package, the target resource package comprising a plurality of target resources on the plurality of application platforms, and a first owner of each of the plurality of target resources being the first object;
receiving a binding request of the first object for a plurality of target resources to be bound in the target resource package, a second owner of each target resource to be bound in a sub-contract corresponding to the target resource to be bound being already registered as the first object;
changing the second owner from the first object to an address of the master contract in response to the binding request, to determine the target resource to be bound as a bound target resource; and
changing a first owner of the bound target resource to a second object in response to an ownership transfer request of the second object for the bound target resource.

2. The method according to claim 1, wherein the deploying a target resource package in the master contract in response to a deployment request of a first object for the target resource package comprises:
allocating a target resource package identifier to the target resource package in response to the deployment request;
receiving an initial target resource list of the target resource package;
recording a mapping relationship between the target resource package identifier and the initial target resource list in a first variable; and
recording the target resource package identifier, the initial target resource list, and the first variable in the master contract.

3. The method according to claim 2, further comprising:
obtaining the target resource package identifier carried in the binding request before the changing the second owner from the first object to an address of the master contract in response to the binding request;
searching for the first variable based on the target resource package identifier, to obtain the initial target resource list; and
determining that the plurality of target resources to be bound fall within the initial target resource list.

4. The method according to claim 3, wherein the initial target resource list comprising information about a plurality of initial target resources, and information about each initial target resource comprising: a first sub-contract address corresponding to an application platform with which the initial target resource is registered, an identifier of the initial target resource, and a quantity of registered initial target resources on the application platform;
the binding request comprises information about the plurality of target resources to be bound, and information about each target resource to be bound comprises: a second sub-contract address corresponding to an application platform with which the target resource to be bound is registered, an identifier of the target resource to be bound, and a quantity of target resources to be bound; and
the determining that the plurality of target resources to be bound fall within the initial target resource list comprises:
determining an initial target resource as an alternative target resource when a first sub-contract address corresponding to the initial target resource in the initial target resource list is equal to a second sub-contract address corresponding to a target resource to be bound, and an identifier of the initial target resource is equal to an identifier of the target resource to be bound; and
determining that the target resources to be bound fall within the initial target resource list based on the quantity of registered alternative target resources and the quantity of target resources to be bound.

5. The method according to claim 4, wherein the determining that the target resources to be bound fall within the initial target resource list based on the quantity of registered alternative target resources and the quantity of target resources to be bound, comprises:
obtaining a second variable, the second variable indicating a quantity of bound target resources in the quantity of registered alternative target resources; and
when a sum of the quantity of bound target resources and the quantity of target resources to be bound is not greater than the quantity of registered alternative target resources, determining that the target resources to be bound fall within the initial target resource list, and adding the quantity of target resources to be bound to the second variable.

6. The method according to claim 4, further comprising:
determining that the first sub-contract address corresponding to the initial target resource is of a first type after obtaining the initial target resource list, the first type indicating that the initial target resource is unreproducible; and
verifying that the quantity of registered initial target resources is 1.

7. The method according to claim 4, wherein the changing the second owner from the first object to an address of the master contract in response to the binding request comprises:
for each target resource to be bound,
changing the second owner of the target resource to be bound to the address of the master contract when the second sub-contract address corresponding to the target resource to be bound is of a first type, and the first type indicates that the initial target resource is unreproducible; and
changing second owners of the quantity of target resources to be bound to the address of the master contract when the second sub-contract address corresponding to the target resource to be bound is of a second type, and the second type indicates that the initial target resource is duplicable.

8. The method according to claim 3, further comprising:
before the obtaining the target resource package identifier carried in the binding request, obtaining a first transmitter of the binding request, and determining the first transmitter as the first object.

9. The method according to claim 1, further comprising:
receiving an unbinding request for a plurality of target resources to be unbound in a plurality of bound target resources; and
for each target resource to be unbound, invoking a resource ownership transfer function in a sub-contract corresponding to the target resource to be unbound, and changing a second owner in the sub-contract to the first object.

10. The method according to claim 9, further comprising:
obtaining the target resource package identifier carried in the unbinding request before the changing a second owner in the sub-contract to the first object;
obtaining the initial target resource list recorded in the master contract based on the target resource package identifier; and
determining that the plurality of target resources to be unbound fall within the initial target resource list.

11. The method according to claim 10, the initial target resource list comprising the information about the plurality of initial target resources, and the information about each initial target resource comprising: the first sub-contract address corresponding to the application platform with which the initial target resource is registered, the identifier of the initial target resource, and the quantity of registered initial target resources on the application platform;
the unbinding request comprises information about the plurality of target resources to be unbound, and information about each target resource to be unbound comprises: a third sub-contract address corresponding to an application platform with which the target resource to be unbound is registered and an identifier of the target resource to be unbound; and
the determining that the plurality of target resources to be unbound fall within the initial target resource list comprises:
determining that a target resource to be unbound falls within the initial target resource list when a first sub-contract address corresponding to an initial target resource in the initial target resource list is equal to a third sub-contract address corresponding to the target resource to be unbound, and an identifier of the initial target resource is equal to an identifier of the target resource to be unbound.

12. The method according to claim 10, the unbinding request further carrying a quantity of target resources to be unbound; and
the method further comprises:
for each target resource to be unbound,
obtaining a second variable, the second variable indicating a quantity of bound initial target resources having identifiers the same as that of the target resource to be unbound;
determining that the quantity of target resources to be unbound is not greater than the quantity of bound initial target resources; and
subtracting the quantity of target resources to be unbound from the second variable.

13. The method according to claim 11, the unbinding request further carrying a quantity of target resources to be unbound; and
the method further comprises:
for each target resource to be unbound,
when the third sub-contract address corresponding to the target resource to be unbound is of the first type, and the first type indicates that the initial target resource is unreproducible, invoking an owner obtaining function in the sub-contract corresponding to the target resource to be unbound to determine the second owner of the target resource to be unbound as the address of the master contract; and
when the third sub-contract address corresponding to the target resource to be unbound is of the second type, and the second type indicates that the initial target resource is duplicable, invoking the owner obtaining function to determine that a quantity of target resources to be unbound whose second owners are the address of the master contract is not less than the quantity of target resources to be unbound.

14. The method according to claim 10, further comprising:
obtaining a second transmitter of the unbinding request before the obtaining the target resource package identifier carried in the unbinding request; and
determining the second transmitter as the first object.

15. The method according to claim 11, the unbinding request further carrying a quantity of target resources to be unbound; and
the invoking a resource ownership transfer function in a sub-contract corresponding to the target resource to be unbound, and changing a second owner in the sub-contract to the first object comprises:
changing the second owner of the target resource to be unbound to the first object when the third sub-contract address corresponding to the target resource to be unbound is of the first type, and the first type indicates that the initial target resource is unreproducible; and
changing second owners of the quantity of target resources to be unbound to the first object when the third sub-contract address corresponding to the target resource to be unbound is of the second type, and the second type indicates that the initial target resource is duplicable.

16. The method according to claim 2, further comprising:
receiving a viewing request of the second object for the target resource package before the changing a first owner of the bound target resource to a second object, the viewing request carrying the target resource package identifier;
searching for the first variable based on the target resource package identifier, to obtain the initial target resource list; and
transmitting the initial target resource list to the second object.

17. An electronic device, comprising a memory and a processor, the memory having a computer program stored therein, and the processor, when executing the computer program, implementing a method for processing blockchain resources, the electronic device corresponding to a blockchain node; the blockchain node being connected to a plurality of application platforms, and maintaining a sub-contract configured for each application platform and a master contract configured for the plurality of application platform on a blockchain; and the method comprising:
deploying a target resource package in the master contract in response to a deployment request of a first object for the target resource package, the target resource package comprising a plurality of target resources on the plurality of application platforms, and a first owner of each of the plurality of target resources being the first object;
receiving a binding request of the first object for a plurality of target resources to be bound in the target resource package, a second owner of each target resource to be bound in a sub-contract corresponding to the target resource to be bound being already registered as the first object;
changing the second owner from the first object to an address of the master contract in response to the binding request, to determine the target resource to be bound as a bound target resource; and
changing a first owner of the bound target resource to a second object in response to an ownership transfer request of the second object for the bound target resource.

18. The electronic device according to claim 17, wherein the deploying a target resource package in the master contract in response to a deployment request of a first object for the target resource package comprises:
allocating a target resource package identifier to the target resource package in response to the deployment request;
receiving an initial target resource list of the target resource package;
recording a mapping relationship between the target resource package identifier and the initial target resource list in a first variable; and
recording the target resource package identifier, the initial target resource list, and the first variable in the master contract.

19. The electronic device according to claim 18, further comprising:
obtaining the target resource package identifier carried in the binding request before the changing the second owner from the first object to an address of the master contract in response to the binding request;
searching for the first variable based on the target resource package identifier, to obtain the initial target resource list; and
determining that the plurality of target resources to be bound fall within the initial target resource list.

20. A non-transitory computer-readable storage medium, having a computer program stored therein, and the computer program, when executed by a processor, implementing a method for processing blockchain resources, the electronic device corresponding to a blockchain node; the blockchain node being connected to a plurality of application platforms, and maintaining a sub-contract configured for each application platform and a master contract configured for the plurality of application platform on a blockchain; and the method comprising:
deploying a target resource package in the master contract in response to a deployment request of a first object for the target resource package, the target resource package comprising a plurality of target resources on the plurality of application platforms, and a first owner of each of the plurality of target resources being the first object;
receiving a binding request of the first object for a plurality of target resources to be bound in the target resource package, a second owner of each target resource to be bound in a sub-contract corresponding to the target resource to be bound being already registered as the first object;
changing the second owner from the first object to an address of the master contract in response to the binding request, to determine the target resource to be bound as a bound target resource; and
changing a first owner of the bound target resource to a second object in response to an ownership transfer request of the second object for the bound target resource.
